(19) United States
(12) Patent Application Publication
(10) Pub. No.: US 2019/0050791 A1
(43) Pub. Date: Feb. 14, 2019

(54) Methods and Apparatus for Automatically Generating and Managing Test Customer Accounts

(71) Applicant: Charter Communications Operating, LLC, St. Louis, MO (US)

(72) Inventors: Peter Larson, Greenwood Village, CO (US); Houshmand Moarefi, Denver, CO (US)

(21) Appl. No.: 15/674,476

(22) Filed: Aug. 10, 2017

(51) Int. Cl. G06Q 10/08; G06F 17/30

(52) U.S. Cl. CPC G06Q 10/087; G06F 17/30979

(57) ABSTRACT

Methods and apparatus for managing test accounts, e.g., automatically managing an inventory of test accounts which can be used to test services available from one or more communications systems or platforms are described. A management system monitors test account usage, searches for test accounts and also takes into consideration future or ongoing development projects to predict the number and type of test accounts which will be required during a future time period. Test accounts are created, modified and/or deleted based on the predictions of future test account usage. User's check out and use test accounts to perform system testing with the management system automatically controlling the number of each type of a plurality of different test accounts which are maintained in a test account inventory.

### FIELD

The present application relates to methods and apparatus for managing test accounts, e.g., automatically managing an inventory of test accounts which can be used to test services available from one or more communications systems or platforms.

### BACKGROUND

Providers of services such as audio, video and/or data services often restrict access to services based on what are referred to as user accounts. Account records often include information as to what services and/or level of services a particular user is entitled to receive with there normally being one account record per user.

Customer records are often used for billing as well as for controlling access to services. In order to test features in as close to real conditions as possible, customer records corresponding to one or more fictitious users are often created so that testers can access services under the name/account of the fictitious user and experience what an actual customer is likely to experience when trying to access a service or make changes to the user's account. Similarly a company representative may access the customer record created for test purposes as if they were serving the customer during a call or account change request to experience as part of a test what the customer representative is likely to encounter when attempting to service a customer. Customer records corresponding to fictitious customers that are created for test purposes may be flagged in the company's billing system so that the fictional customers are not treated as paying customers for company financial reporting purposes.

The creation, maintenance and use of customer records corresponding to fictitious customers presents a company with many challenges and risks. From a creation and management perspective it can be labor intensive to determine what attributes and/or features should be included in fictitious accounts and how many accounts with particular combinations of features should be created and/or maintained at any given time.

While it might seem to an inexperienced individual that maintaining large numbers of fictitious accounts for test purposes would be easy and desirable the creation and management of such accounts is often no easy task. Often the reason for testing using accounts is to test new services or offerings which correspond to a new combination of services. Existing accounts of customers may not include the sets of features or attributes which are needed to test a new service or offering. In such cases the people planning a new product or service combination may have to manually request that fictitious customer accounts be created with the desired combination of attributes that would allow for them to test their new service or feature combination and then the new accounts with the desired attributes would need to be created in response to the manually submitted request.

While communicating and/or determining what combination of attributes/features testers want included in fictitious customer accounts, e.g., test accounts, is one technical problem that needs to be addressed, another problem relates to the number of test accounts with a particular combination of features that should be created and/or maintained. Still another problem relates to maintaining security with regard to the use of such test accounts.

It should be appreciated that while the customer accounts created for test purposes may be fictitious, the services which are accessed through the user of such accounts is not. Accordingly, when large numbers of test accounts are created, that are not needed, the chance of one or more of the test accounts being used in an unauthorized manner to gain access to services increases.

In view of the above, it should be appreciated that there is not only a need for methods and/or apparatus which facilitates determination of what types of accounts are to be recreated for test purposes and/or creates such accounts, there is also a need for methods and/or apparatus for determining the number of test accounts of a particular type that should be created or maintained. There is also a need for methods and apparatus for restricting access to test accounts and/or tracking the use of test accounts.

### SUMMARY OF THE INVENTION

Methods and apparatus for automating the collection of information which can be used to determine the number and/or features of accounts to be created and/or maintained are described. In addition various features relate, in some embodiments, to the automatic generation of test accounts and/or tickets requesting the generation of test accounts. Still other features related to the maintenance of a set of customer test accounts in an automated manner and the controlling of access to test accounts.

In various embodiments individuals seeking to use customer test accounts are provided an opportunity to search on an existing set of test accounts to determine if an exiting test account is available which satisfies the needs of a test to be preformed.

The combination of features of an account on which the tester searches is monitored. If the tester's search criteria are satisfied by one or more existing test accounts the tester is provided with a list of accounts satisfying from the search criteria. The tester can then use one or more of the test accounts.

To use a test account the tester logs into a test account administration system using his/her company Email address. The tester selects an account and requests check out at which point the system presents the tester with the credentials for the account. In some, but not necessarily all embodiments, an Email is sent to the tester providing the tester with a current password and user name corresponding to the selected test account. The test account management system logs that the test account has been allocated to the tester and other testers are blocked from using the test account while it is allocated to a particular tester. When done with testers returns control of the test account by indicating to the test account administration system that they are no longer using the particular test account or account(s) allocated to the particular tester.

The test account administration system keeps track of which accounts have been allocated and when. Test accounts which go unused for extended periods of time are identified and selected for automatic deletion to avoid the existence of accounts which are not being used.

The combinations of features in test accounts which are used are documented. To ensure an ample supply of accounts for use with different variations of features, in some embodiments new accounts are created having the combination of identified features along with various variants of other account features. Thus testers are given the chance to use accounts satisfying their search constraints but which have various combinations of features the testers may not have contemplated or requested. This approach to automatic test account generation facilitates the detection of feature incompatibilities that might not have been considered by the testers or identified for testing.

In addition to generating additional accounts satisfying tester searches, searches for accounts with particular combinations of features which are not satisfied by the existing set of accounts are documented and a ticketed requesting creating of an account having the searched for set of features is automatically generated and/or a customer test account having the set of searched for features is automatically generated. For example, when a search is conducted for an account to use a new service is detected and there is no account with authorization to use the new service, a test customer account with authorization to use the new service is automatically created and/or a ticket requesting creation of a new test account for the service is automatically created.

The number of satisfied and unsatisfied searches for accounts having particular sets of features are tracked over time and used in controlling the number of test accounts created and/or maintained with the searched for features. In this way the number of accounts and features of the test accounts is maintained taking into consideration the testers needs while avoiding the need in many cases for explicit requests for account creation from the testers using the system.

Numerous variations on the above described methods and apparatus are possible.

### BRIEF DESCRIPTION OF THE FIGURES

FIG. 1 is a drawing of an exemplary communications system including a test account management system in accordance with an exemplary embodiment.

FIG. 2 is drawing of an exemplary test account management system in accordance with an exemplary embodiment.

FIG. 3A is a first part of a flowchart of an exemplary automated test account management method in accordance with an exemplary embodiment.

FIG. 3B is a second part of a flowchart of an exemplary automated test account management method in accordance with an exemplary embodiment.

FIG. 3C is a third part of a flowchart of an exemplary automated test account management method in accordance with an exemplary embodiment.

FIG. 3D is a fourth part of a flowchart of an exemplary automated test account management method in accordance with an exemplary embodiment.

FIG. 3 comprises the combination of FIG. 3A, FIG. 3B, FIG. 3C and FIG. 3D.

FIG. 4A is a first part of an exemplary automated test account management method in accordance with an exemplary embodiment.

FIG. 4B is a second part of an exemplary automated test account management method in accordance with an exemplary embodiment.

FIG. 4 comprises the combination of FIG. 4A and FIG. 4B.

FIG. 5 is a flowchart of an exemplary inventory creation, e.g., test account creation, method in accordance with an exemplary embodiment.

FIG. 6 is a drawing of an exemplary account search user input display screen in accordance with an exemplary embodiment.

FIG. 7 is a drawing of an exemplary account search user input display screen included user selected input in accordance with an exemplary embodiment.

FIG. 8 is a drawing of an exemplary account search results displayed in response to the search input of FIG. 7.

FIG. 9 is a drawing of exemplary account search results displayed in response to another search.

FIG. 10 is a drawing of an exemplary set of information elements, e.g., a test account record, corresponding to an exemplary test account, identified in FIG. 9, in accordance with an exemplary embodiment.

FIG. 11 is a drawing of exemplary account search results displayed in response to yet another search.

FIG. 12 is a drawing of an exemplary set of information elements, e.g., a test account record, corresponding to an exemplary test account, identified in FIG. 11, in accordance with an exemplary embodiment.

FIG. 13 is a drawing of an exemplary test account edit screen in accordance with an exemplary embodiment.

FIG. 14A is a first part of an exemplary assembly of components which may be included a test account management system in accordance with an exemplary embodiment.

FIG. 14B is a second part of an exemplary assembly of components which may be included a test account management system in accordance with an exemplary embodiment.

FIG. 14C is a third part of an exemplary assembly of components which may be included a test account management system in accordance with an exemplary embodiment.

FIG. 14 comprises the combination of FIG. 14A, FIG. 14B and FIG. 14C.

### DETAILED DESCRIPTION

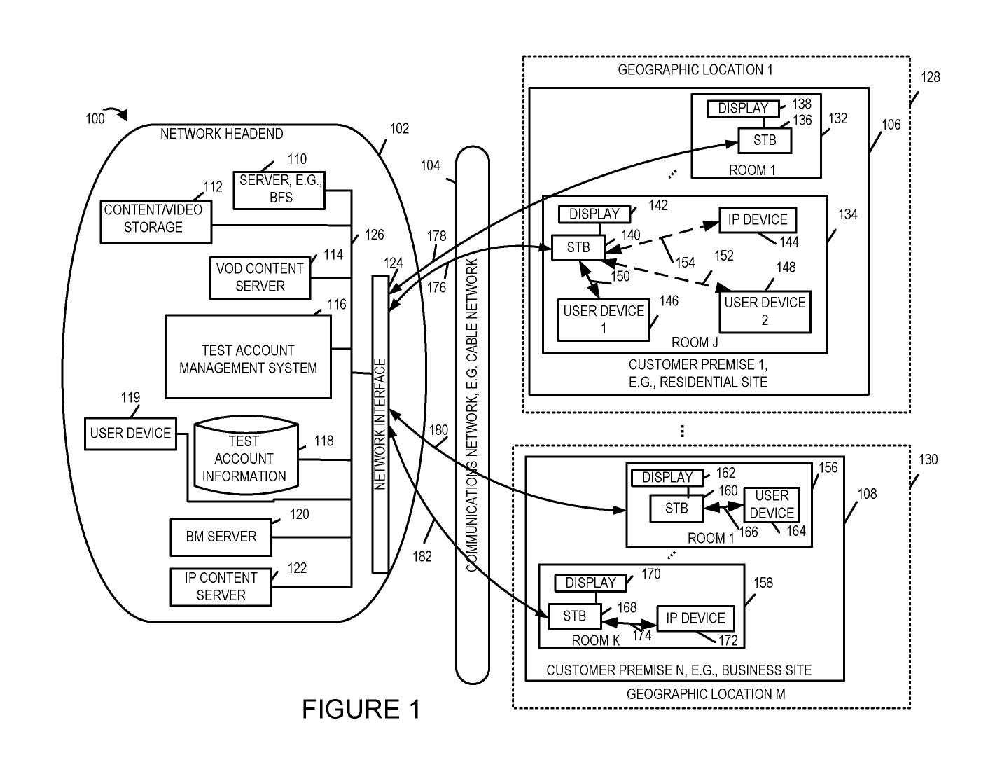

FIG. 1 illustrates a system 100 which can be used to provide various services via a communications network 104 to multiple different geographic regions 128, 130 in which one or more customer premises 106, 108 are located. The customer premises may be residential sites 106, commercial business customer sites 108 and/or other types of sites or locations which can receive services, e.g., video, audio, and/or data services from one or more devices located in the network headend 102. The network headend 102 includes various devices for providing services and/or information such as a broadcast file server 110 which may broadcast TV programs and/or program guide information, content/video storage device 112 for storing audio, video and/or other content that can be streamed or supplied to playback devices by the VOD content server 114 or IP content server 122. The network headend also includes a test account management system 116, a data storage device including test account information, e.g., an inventory of various test accounts which a tester can check out and then use to obtain services as part of a testing process. The test accounts are like regular customer accounts and include customer information that a normal customer account would include such as name, address and other information such as entitlement information indicating which service or services the user of the test account is entitled to receive. Test account information 118 may also include a record of which employee of a communications service provider, e.g., technician, is authorized to use an account or accounts at a particular time. The test account management system 116 manages the inventory, e.g., set or sets, of test accounts which are available at a given time and tracks, e.g., keeps a record of, which individual to which the test account has been allocated, e.g., checked out to, at a given time. A test account which has been allocated to a tester is described as being “checked out” and can be used to receive services just like an actual account. When a tester is done with the use of the account it is checked back in and indicated to be available for use by another tester. In some embodiments, a tester can only use one account at any given time and the identity of the tester using an account is recorded as part of the checkout process. The test account management system 116 not only tracks use of test accounts and, as a result of the checkout/checkin process knows which test accounts are in use or out of use at a given time, it automatically controls, in some embodiments of the invention, the total number of test accounts and/or the combination of features, e.g., set of service entitlement information, customer location information, billing information, etc. that are included in each of the test accounts with the test accounts including information which is the same or similar to that included in actual customer service accounts. While the test accounts may include information for testing deployed services in some cases test accounts are created for services which are not yet deployed and/or which are to be tested prior to the new service being made available to normal paying customers.

Since the test accounts in the test account information 118 can be used to obtain actual services, e.g., video on demand services, data services, etc. control of the test accounts is important to avoid use by non-paying individuals. The larger the number of test accounts the more difficult it is to track and manage and to avoid unauthorized use of one or more of the test accounts.

A user of a test account may use a user device, such as the user device 119, to test the ability of a user device to obtain services the test account being used should be entitled to receive. Test accounts can also be used to determine if the business management server 120 properly accesses account information, can make changes to account information of a customer to whom the test account is indicated to correspond to and/or if particular combinations of services will cause conflicts or other problems. To be able to test various combinations of features and/or services a variety of different test accounts may be maintained in inventory.

In accordance with the invention the test account system 116, monitors test account usage information, searches conducted by technicians for test accounts with various combinations of features and/or test account information elements, e.g., service entitlement information, location information, etc. and can automatically make change to the inventory based on differences between the number of test accounts of particular types in the inventory included in the database 118 and the predicted number of test accounts of various types that the test account management system predicts will be needed in the future based on various inputs and/or measurements. The measurements may involve, e.g., measurements of test account utilization, the number of unused test accounts of a particular type, the number of times a user searches for test accounts having a particular combination of features or services results in a failure to find any available test accounts have the searched for combination of features, etc.

As will be discussed below the test account management system 116 may and sometimes does automatically generate test accounts, modify test accounts and/or delete test accounts based on a comparison of predicted future test account needs and current detected test account utilization rates. The number of available test accounts of a particular type may be and sometimes is automatically modified when the predicted number of test accounts of a particular type to be required does not exceed the actual number of test accounts in the inventory 118 by a predetermined amount sometimes referred to as a margin. Different margins may be used for accounts of different types. For example test accounts corresponding to a program under deployment may have a higher margin than test accounts corresponding to a previously deployed service or platform which was previously tested. This is because a new platform or service may need to undergo more testing and using a large number of test accounts in an attempt to identify bugs or problems prior to commercial deployment. As part of the account management process the test account management system may modify test accounts leaving for example, a customer name and address unchanged but with an information element of the account indicating the service or services to which the customer is entitled to use being changed to test a new or different combination of services to which a customer may subscribe.

The business management server 120 can authorize a customer to receive, on a user device 119 146, 172, or 164 one or more services based on the service authorization information in a test account just as it would authorize the services of a paying customer based on the information in the paying customer's account.

The various devices in the network headend 102 are coupled together by bus a 126 and/or network to the network interface 106 that coupled the elements of the network headend to the communications network 104. The communications network 104 may be and sometimes is a cable or fiber network which allows devices in the network headend 102 to supply content and/or services to the customer premises 106, 108 and the devices located at such premises.

In some cases the user device 119 which uses one or more test accounts is located at the network headend 102 or at another service provider location. In other cases, field tests may be performed with the user device 146 for example or IP device 172 being used by a technician to obtain and test services by using one or more of the customer service test accounts included in the test account database 118.

The first customer premise includes a first room 132 that includes a set top box 136 and display 138 which are coupled via connection 178 through the communications network 104 to the network interface 124 of the network head end 102. In this way services can be provided to the STB 136 which can display content on the display 138. Tests may need to be conducted at different geographic locations so test accounts may be generated for different locations 128, 130 in addition to different combinations of services or features to allow actual field testing.

The second customer premise 130 includes, in a first room 156, a display 162, STB 160 and a user device 164 which can receives services via link 180 from the devices at the network headend. As with other services the BM server 120 or another device may be responsible for authorizing services of test account users the same as it would for regular paying customers.

A second room K 158 includes a display 170, STB 168 and a user IP device 172 which is coupled to the STB by a communications link 174 which may or may not be wireless. The IP device 172 is a user device which, when used by an employee of the service or network provider, can use a test account to receive services via link 180 from the devices at the network headend.

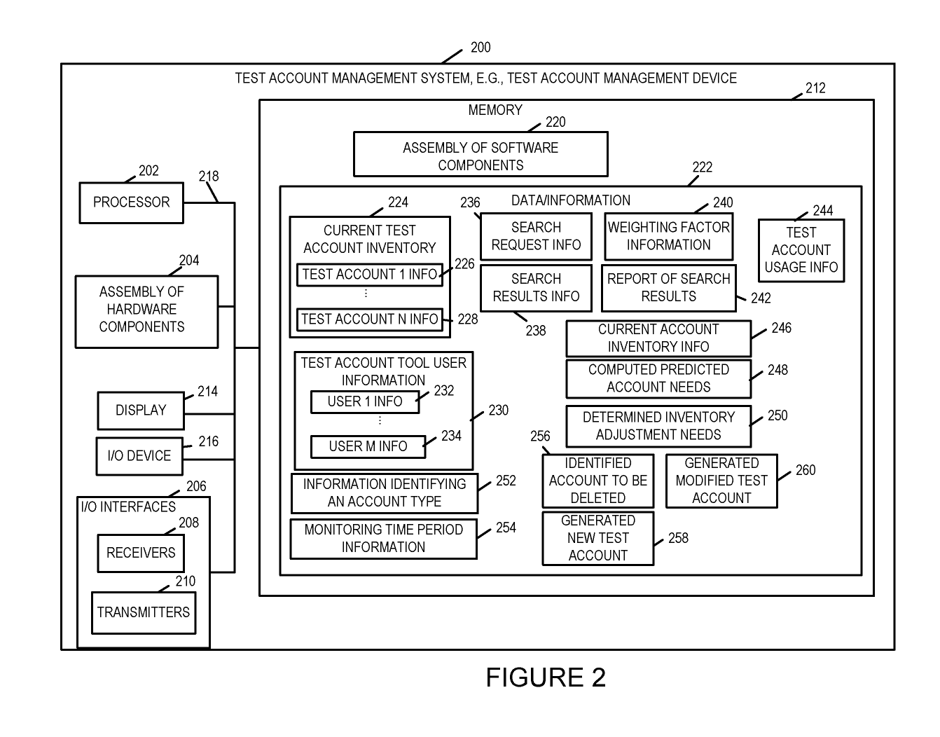

FIG. 2 illustrates an exemplary test account management system 200 which can be and sometimes is used as the test account management system 116 of FIG. 1. The test account management system 200 includes a processor 202, assembly of hardware components 204, a display 214, an input/output (I/O) device 216, I/O interfaces 206 including one or more receivers 208 and one or more transmitters 210 which may be wired or wireless components used for coupling the management system 200 to the bus 126 and/or communications network 104. The system 200 further includes a memory 212 which is coupled to the other components of the system 200 by bus 218 as shown in FIG. 2.

The memory includes an assembly of software components 220 which can be executed by the processor 202 and which can be used to control the account management system 212 to perform one, several or all of the steps of the described methods and/or steps performed by the account management system. Rather than use software components 220 hardware components 204 may be used to implement one or more steps of the method or to control the management system to implement a step of the method or methods described herein.

In addition to software components 220 which control system operation in some embodiments, the memory 212 includes data/information 222. The data/information includes a current test account inventory 224 which includes a plurality of test accounts 226, 228 which may be and sometimes are logged or “checked” out of the inventory for use by one or more individuals responsible for performing testing. While the test account inventory 224 is shown in the memory of the test account management system 200 it should be appreciated that in some embodiments the inventory of test accounts is stored in test account information database 118 which is external to the test account management system 116.

When a test account is “checked out” it can be used for testing with the account being limited to use by a single person at a given time. A status bit may be and sometimes is included in the test account information or user test account 226, 228 and which is set to a first value, e.g., 1 when a test account is “checked out” and to a second value, e.g., “0” when it is not.

As part of checking out a test account, a record is created identifying the individual who checked out the particular test account along with time information so that if unauthorized use is detected or the account is used to obtain services which are not part of a testing process the use of the account at a given time can be traced to a particular employee or individual who checked the account out. An account which is checked out is considered in use. When an account is returned or “checked in” to be made available in the inventory 224 to other employees, the use record is updated to reflect that the individual employee is no longer using the particular test account and the account is no longer considered in use. If use of the account while in the “checked in” state is detected, an alert can be, and in some embodiments is, generated for unauthorized use.

The memory includes test account user tool information on a per user basis. The user 1 information 232 includes information identifying a particular user, e.g., employee, by name and/or an employee ID. The user information 232 further includes information indicating what test account or accounts user 1 “checked out” and when. The user 1 information 232 includes information identifying a particular user, e.g., employee, by name and/or an employee ID. The user M information 234 includes information which is the same or similar to the information included in user information record 232 but for a different user, user M, rather than for user 1 to which the first user information 232 corresponds.

The memory 222 further includes information identifying one or more account types 252. The information 252 includes, for different types of accounts, a minimum set of account content or information that should included in an account of a particular type. Thus, the information defining an account type defines a minimum set of information values or particular requirements for an account to be considered as an account of the defined type. For example, a first type account might be a cable network account corresponding to geographic location 1 128 and thus would include a service type information element indicating that the account is for cable service and a customer premise location indicator with a value identifying geographic location 1. While the account type may require a particular minimum set of information elements (field values) an account of a particular type may have additional information elements which may vary from one account to another of the given type. For example accounts of a first type may include customer name fields which will be different from one account of the first type to another account of the first type.

The memory also included monitoring time period information 254 which can include a value indicating how long a particular type of information or activity should be monitored before the results of the monitoring are used for controlling updating of the user test account inventory 224. For example the number of unused accounts of a particular type may be monitored for a first time period indicated in information set 254 while information 254 may indicate that search results should be monitored for a second period of time which is different from said first period of time before the results of such monitoring are used to predict future account usage.

The data included in memory also includes search request information 236 which can indicate what sets of information were searched on for purposes of user account selection and what the values in the search fields were for one or more searches. The values used to conduct a search may define a particular type of test account for which one or more users were searching. Search result information field 238 includes information on search results such as how many user test accounts satisfied a particular search as well as what searches went unsatisfied and, for a given unsatisfied search which information element or field of the search was not satisfied. This facilities identifying what element or elements in an exiting record might need to be modified to make sure the search will be satisfied in the future by one or more test accounts.

Weighting factor information 240 includes information on how to weight different pieces of information, e.g., values or counts, that are used in some embodiments to generate a prediction of future account usage. Report of search results 242 includes information on the results of one or more searches, e.g., how many test accounts in the current inventory satisfied a particular search for test accounts. Test account usage information 244 includes information about the number of test accounts of a particular type were in use at a given time. Usage information may be and sometimes is maintained for each of a plurality of different types of test accounts. The test account usage information 244 may and sometimes also does include information on which particular accounts have gone unused for one or more time periods. This facilitates the identification of accounts which have not been used for an extended period of time so that they can be deleted or modified, e.g., to increase the chance that they will satisfy a future search, e.g., for a new or ongoing program or content delivery platform.

Current account inventory information 246 includes information on the total number of accounts in the current inventory as well as the number of test accounts of each particular type in the current inventory 224.

Computed predicted account needs 248 includes information indicating how many accounts of the various different types included in the inventory are expected to be needed in a future time period. The computed predicted account needs 248 can be and sometimes are computed as will be discussed below from past detected usage as well as the number of searches being conducted for particular types of accounts among other things. Determined inventory adjustment needs 250 includes information about changes to the test account inventory which should be made, e.g., information including which accounts should be deleted, what types of accounts should be added and what accounts or types of accounts should be modified so that they are more likely to be used in the future.

Information 256 includes information identifying one or more accounts to be deleted where such accounts are sometimes identified in an automated manner by the system 200. Element 260 is a modified test account generated by modifying an information element or content in an existing account, e.g., to make it more likely to satisfy a search for a user test account in the future. Generated new test account 258 is a test account which was generated to increase the number of test accounts in the inventory, e.g., to satisfy an expected increase in the need for test accounts of a particular type.

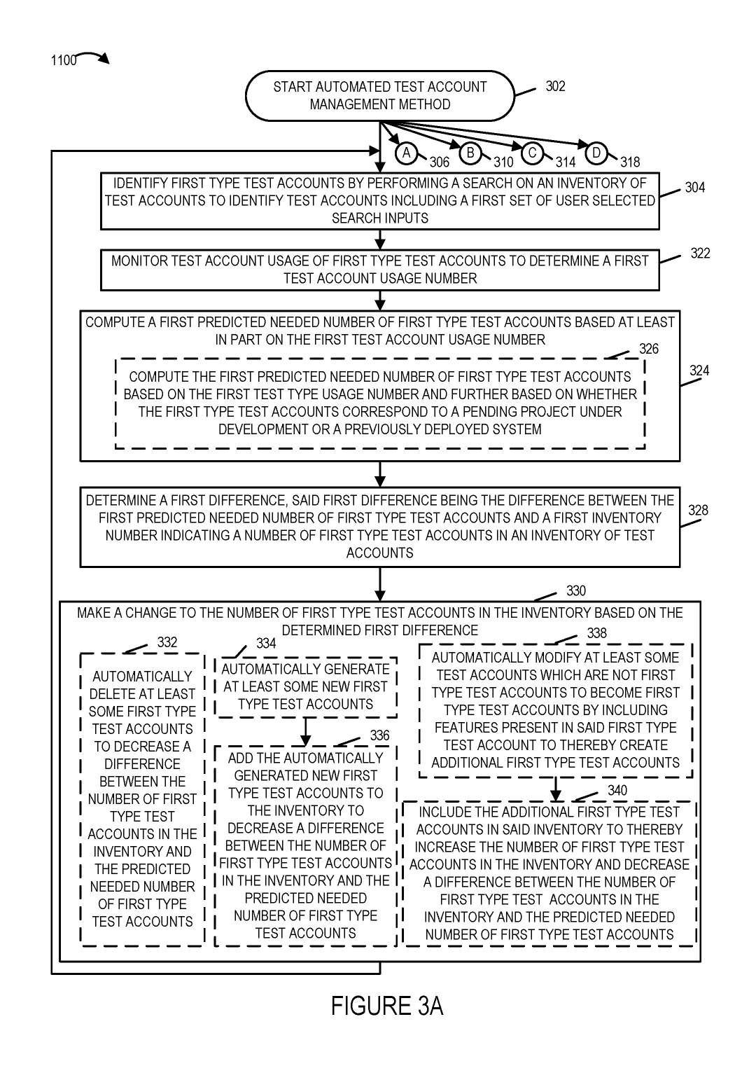

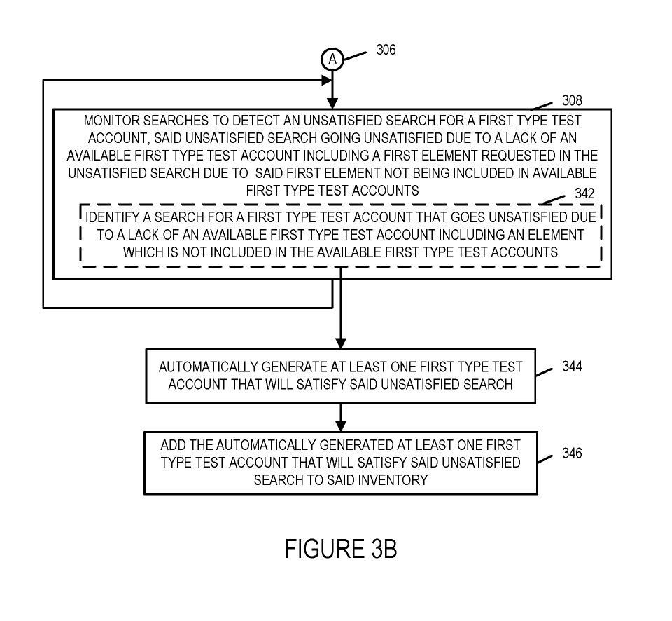

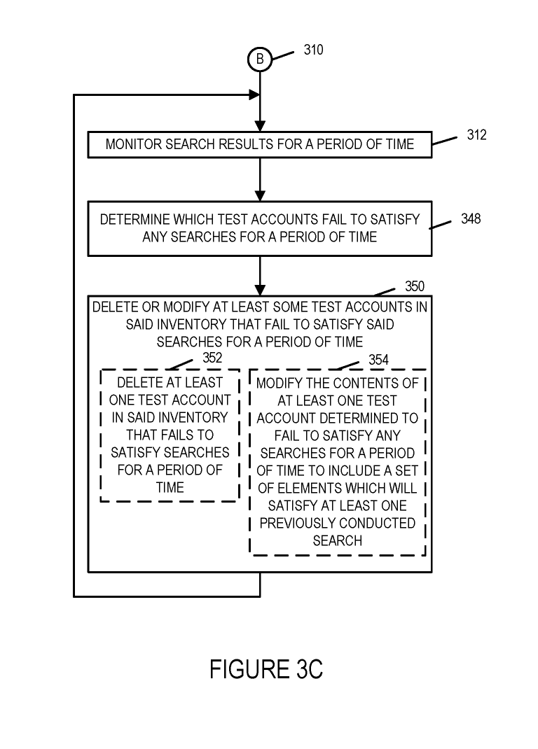

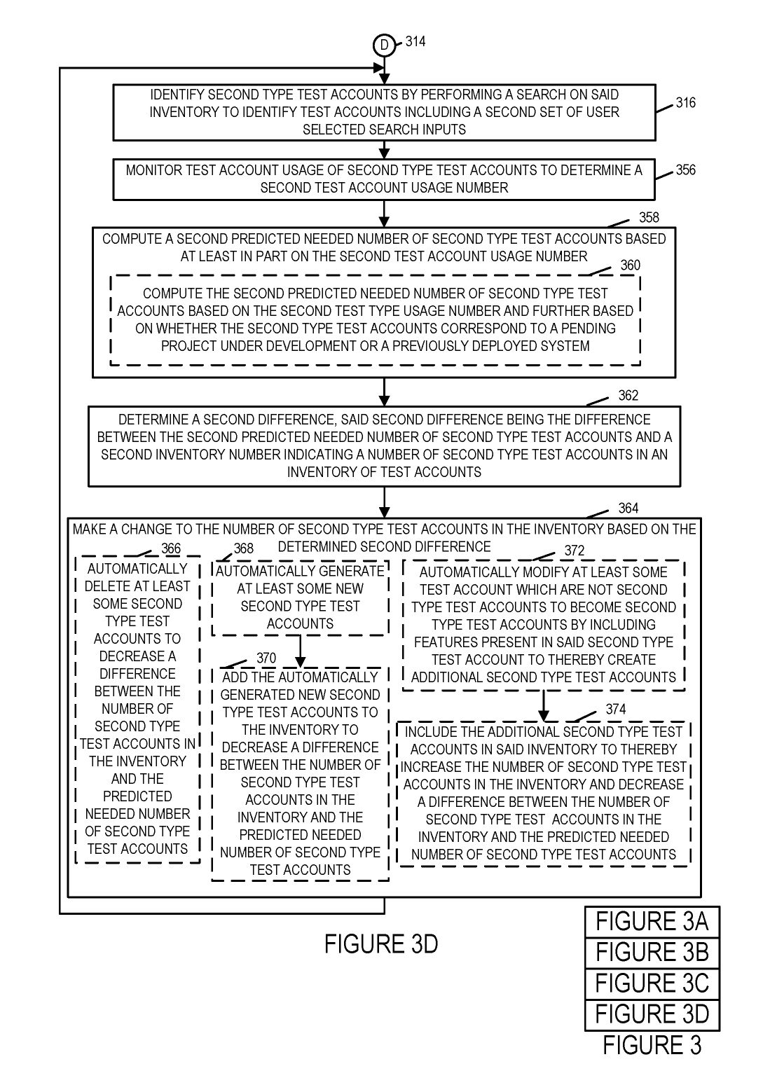

FIG. 3, comprising the combination of FIG. 3A, FIG. 3B, FIG. 3C and FIG. 3D, is a flowchart 300 of an exemplary method of operating a test account management system to implement a test account management method in accordance with an exemplary embodiment. In some embodiments the test account management system implementing the method of flowchart 300 is test account management system 116 of FIG. 1 or test account management system 200 of FIG. 2. Operation of the exemplary method starts in step 302, in which the test account management system is powered on and initialized. Operation proceeds from step 302 to: step 304, step 308 via connecting node A 306, step 312 via connecting node B 310, step 316 via connecting node C 314, and step 320 via connecting node D 318.

In step 304, the test account management system identifies first type test accounts by performing a search on an inventory of test accounts to identify test accounts including a first set of user selected search inputs. In some embodiments, the user selected search inputs include at least two of: a project, billing instance, provisioning method and franchise. In some embodiments, the user selected search inputs include at least two of: a line of business, video entitlements, and equipment required status. In some embodiments, the user selected search inputs include at least two of: a billing environment, environment, and equipment status. In some embodiments, first type test accounts are test accounts which satisfy a first set of test account features. Operation proceeds from step 304 to step 322. In step 322 the test account management system monitors test account usage of first type test accounts to determine a first test account usage number, e.g., a number of first type test accounts used, e.g., checked out for use in testing, during a first time period. Operation proceeds from step 322 to step 324.

In step 324 the test account management system computes a first predicted needed number of first type test accounts based at least in part on the first test account usage number, e.g., predict how many first type test accounts will be needed in an upcoming time period. In some embodiments, step 324 includes step 326 in which the test account management system computes the first predicted needed number of first type test accounts based on the first test type usage number and further based on where the first type test accounts correspond to a pending project under development or a previously deployed system. Operation proceeds from step 324 to step 328.

In step 328 the test account management system determines a first difference, said first difference being the difference between the first predicted number of first type test accounts and a first inventory number indicating a number of first type accounts in an inventory of test accounts. Operation proceeds from step 328 to step 330.

In step 330 the test account management system makes a change to the number of first type test accounts in the inventory based on the determined first difference. Step 330 includes one or more of step 332, 334, 336, 338 and 340. In various embodiments, during different iterations of step 330 one of: i) steps 332, ii) steps 334 and 336, or iii) steps 338 and 340 are performed. In some embodiments, during at least some iterations of step 330, steps 334, 336, 338, and 340 are performed.

In step 332 the test account management system automatically deletes at least some first type test accounts to decrease a difference between the number of first type test accounts in the inventory and the predicated needed number of first type test accounts.

In step 334 the test account management system automatically generates at least some new first type test accounts. Operation proceeds from step 334 to step 336, in which the test account management system adds the automatically generated new first type test accounts to the inventory to decrease a difference between the number first type test accounts in the inventory and the predicted needed number of first type test accounts.

In step 338 the test account management system automatically modifies at least some test accounts which are not first type test accounts to become first type test accounts by including features present in said first type test account to thereby create additional first type test accounts. Operation proceeds from step 338 to step 340. In step 340 the test account management system includes the additional first type test accounts in said inventory to thereby increase the number of first type test accounts in the inventory and decrease a difference between the number of first type test accounts in the inventory and the predicated needed number of first type test accounts. Operation proceeds from step 330 to the input of step 304.

Returning to step 306, in step 306 the test account management system searches to detect an unsatisfied search for a first type test account, said unsatisfied search going unsatisfied due to a lack of an available first type test account including a first element requested in the unsatisfied search due to said first element not being included in the available first type test accounts. Step 308 includes step 342, which is performed in some iterations on step 308. In step 342 the test account management system identifies a search for a first type test account that goes unsatisfied due to a lack of an available first type test account including an element which is not included in the available first type test accounts. Operation proceeds from step 342 to step 344.

In step 344 the test account management system automatically generates at least one first type test account that will satisfy said unsatisfied search. Operation proceeds from step 344 to step 346. In step 3456 the test account management system adds the automatically generated at least one first type test account that will satisfy said unsatisfied search to said inventory.

Returning to step 312, in step 312 the test account management system monitors search results for a period of time. Operation proceeds from step 312 to step 348, in which the test account management system determines which test accounts fail to satisfy any searches for a period of time. Operation proceeds from step 348 to step 350. In step 350 the test account management system deletes or modifies at least some test accounts in said inventory that fail to satisfy said searches for a period of time. Step 350 includes one or both of steps 352 and 354. In step 352 the test account management system deletes at least one test account in said inventory that fails to satisfy searches for a period of time. In step 354 the test account management system modifies the contents of at least one test account determined to fail to satisfy any searches for a period of time to include a set of elements which will satisfy at least one previously conducted search.

Returning to step 316, in step 316, the test account management system identifies second type test accounts by performing a search on an inventory of test accounts to identify test accounts including a second set of user selected search inputs. In various embodiments, the said second type test accounts are accounts which satisfy a second set of test account features, said second set of test account features being different from the first set of test account features. Operation proceeds from step 316 to step 356. In step 356 the test account management system monitors test account usage of second type test accounts to determine a second test account usage number, e.g., a number of second type test accounts used, e.g., checked out for use in testing, during the first time period. Operation proceeds from step 356 to step 358.

In step 358 the test account management system computes a second predicted needed number of second type test accounts based at least in part on the second test account usage number, e.g., predict how many second type test accounts will be needed in an upcoming time period. In some embodiments, step 358 includes step 360 in which the test account management system computes the second predicted needed number of second type test accounts based on the first test type usage number and further based on where the second type test accounts correspond to a pending project under development or a previously deployed system. Operation proceeds from step 358 to step 362.

In step 362 the test account management system determines a second difference, said second difference being the difference between the second predicted number of second type test accounts and a second inventory number indicating a number of second type test accounts in an inventory of test accounts. Operation proceeds from step 362 to step 364.

In step 364 the test account management system makes a change to the number of second type test accounts in the inventory based on the determined second difference. Step 364 includes one or more of step 366, 368, 370, 372 and 374. In various embodiments, during different iterations of step 364 one of: i) step 366, ii) steps 368 and 370, or iii) steps 372 and 3374 are performed. In some embodiments, during at least some iterations of step 364, steps 368, 370, 372, and 374 are performed.

In step 366 the test account management system automatically deletes at least some second type test accounts to decrease a difference between the number of second type test accounts in the inventory and the predicated needed number of second type test accounts.

In step 368 the test account management system automatically generates at least some new second type test accounts. Operation proceeds from step 368 to step 370, in which the test account management system adds the automatically generated new second type test accounts to the inventory to decrease a difference between the number second type test accounts in the inventory and the predicted needed number of second type test accounts.

In step 372 the test account management system automatically modifies at least some test accounts which are not second type test accounts to become second type test accounts by including features present in said second type test account to thereby create additional second type test accounts. Operation proceeds from step 372 to step 374. In step 372 the test account management system includes the additional second type test accounts in said inventory to thereby increase the number of second type test accounts in the inventory and decrease a difference between the number of second type test accounts in the inventory and the predicated needed number of second type test accounts. Operation proceeds from step 330 to the input of step 304.

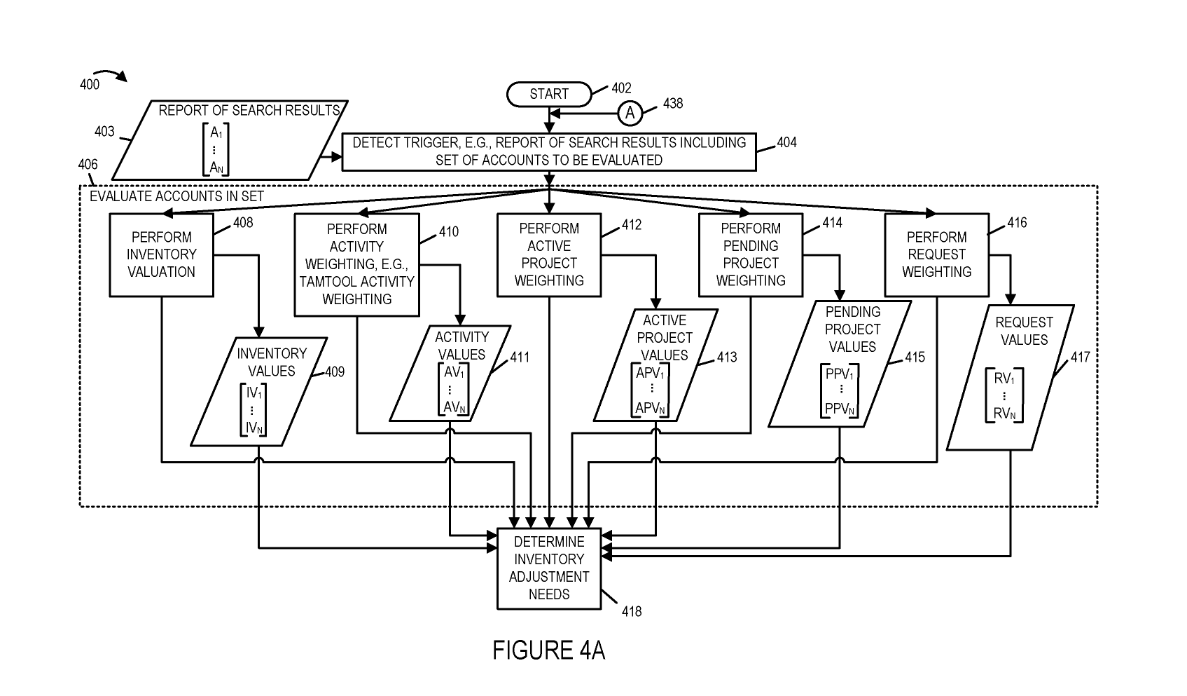

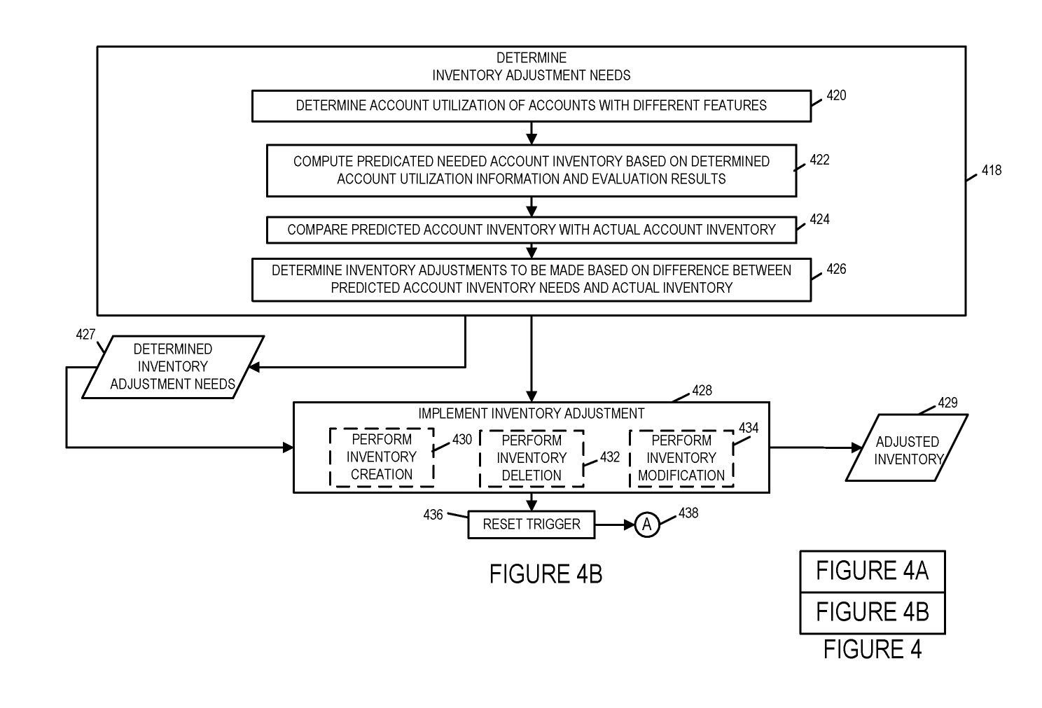

FIG. 4, comprising the combination of FIG. 4A and FIG. 4B, is a flowchart of an exemplary method of operating a test account management system in accordance with an exemplary embodiment. In some embodiments, the test account management system implementing the method of flowchart 400 is test account management system 118 of FIG. 1 or test account management system 200 of FIG. 2. Operation of the exemplary method starts in step 402 in which the test account management system is powered on and initialized. Operation proceeds from start step 402 to step 404. In step 404 the test account management system detects a trigger, e.g., a report of search results 403 including a set of test accounts. In various embodiments, the report of search results includes search result information corresponding to each account in the set of accounts. In one example the set of accounts is the set {test account A1, test account A2, . . . , test account AN}. In some embodiments, the report of search results corresponds to a set of test accounts which is a subset of a current test account inventory.

Operation proceeds from step 404 to step 406. In step 406, the test account management system evaluates accounts in the set. Step 406 includes steps 408, 410, 412, 414, and 416. In step 408 the test account management system performs an inventory valuation and generates inventory values {V1, V2, . . . , VN} 409. Some types of test account may be, and sometimes are, valued higher than other types, e.g., based on critically of a certain test, project deadlines, repair deadlines, etc. In step 410 the test account management system performs an activity weighting, e.g., a Tamtool activity weighting, and generates activity values {AV1, AV2, . . . , AVN} 411. In various embodiments, test accounts which are used more frequently received higher activity values than less frequently used test accounts. In step 412 the test account management system performs an active project weighting and generates active project weighting values {APV1, APV2, . . . , APVN} 413. In various embodiments, test accounts which are used by active projects, e.g., deployed projects, receive a positive active project value, e.g., a predetermined positive value, and test accounts which are used by pending projects receive an active project value of 0. In step 414 the test account management system performs a pending project weighting and generates pending project values {PPV1, PPV2, . . . , PPVN} 415. In various embodiments, test accounts which are used by pending projects, e.g., development projects, receive a positive pending project value, e.g., a predetermined positive value, and test accounts which are used by active projects receive a pending project value of 0. In step 416 the test account management system performs request weighting and generates request weighting values {RV1, RV2, . . . , RVN} 415. In various embodiments, test accounts which are highly requested received higher request weighting values than test accounts which are less frequently requested.

Operation proceeds from step 406 to step 418, in which the test account management system determines inventory adjustment needs using the generated information (409, 411, 413, 415, 417) from the evaluations of step 406. Step 418 includes steps 420, 422, 424, and 426. In step 424 the test account management system determines account utilization of accounts with different features. Operation proceeds from step 420 to step 422. In step 422 the test account management system computes predicted account inventory based on the determined account utilization information and the evaluation results. Operation proceeds from step 422 to step 424. In step 424 the test account management system compares the predicated account inventory with the actual account inventory. Operation proceeds from step 424 to step 426. In step 426 the test account management system determines inventory adjustments to be made based on differences between the predicated account inventory needs and the actual account inventory. Determined inventory adjustments needs 427 is an output of step 418. In some embodiments, determined inventory adjustment needs 427 include one or more or all of: i) inventory creation records, ii) inventory deletion records and iii) inventory modification records. Operation proceeds from step 418 to step 428.

In step 428 the test account management system implement the inventory adjustment using the determined inventory adjustment needs 427 as input. In various embodiments, step 428 includes one or more or all of steps 430, 432 and 434. In step 430 the test account management system performs inventory creation, e.g., generating one or more new test accounts. In step 432 the test account management system performs inventory deletion, e.g., deleting one or more existing test accounts which have not been used in a predetermined time or which have a low overall rating. In step 434 the test account management system performs inventory modification, e.g., changing an existing test account, e.g., a existing account with a low overall rating, to generate a modified account expected to be more suitable in respect to current testing needs. Adjusted inventory 429 is an output of inventory adjustment step 428. Operation proceeds from step 428 to step 436 in which the test account management system resets the trigger. Operation proceeds from step 436, via connecting node A 438, to step 404.

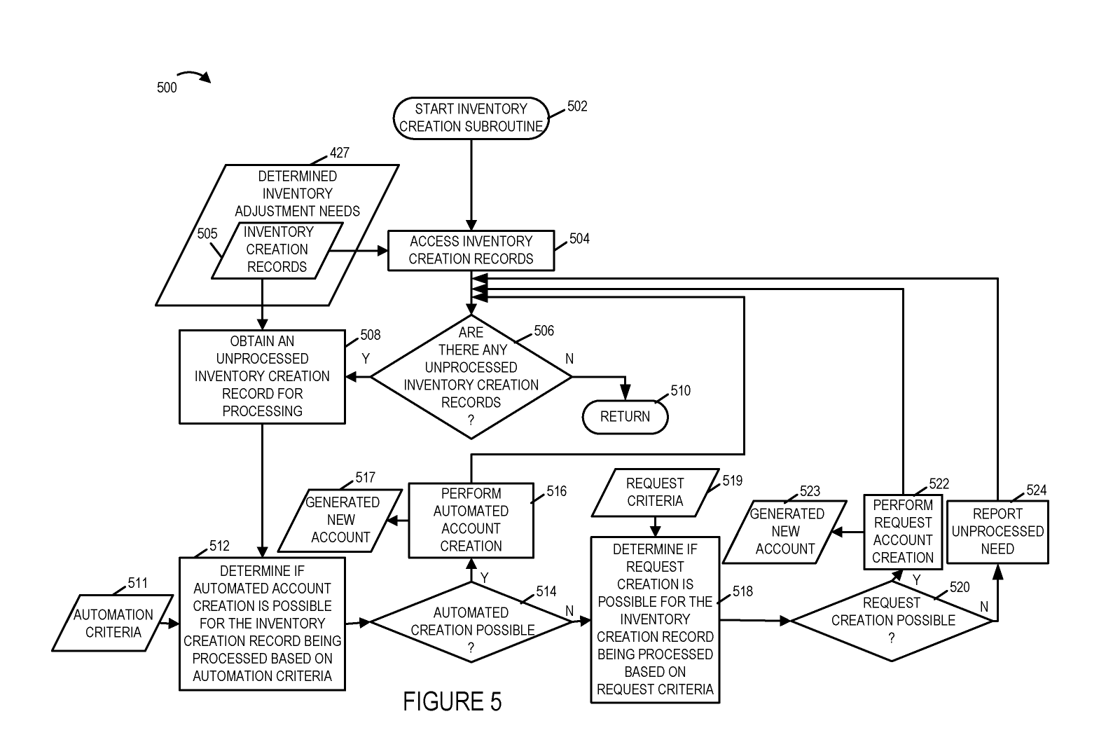

FIG. 5 is a flowchart 500 of an exemplary method of performing inventory creation in accordance with an exemplary embodiment. In some embodiments the inventory creation method of flowchart 500 is used by the test account management system to implement step 430 of flowchart 400 of FIG. 4. The exemplary inventory creation method starts in step 502 and proceeds to step 504. In step 504 the test account management system access inventory creation records 505 of determined inventory adjustment needs 427. Operation proceeds from step 504 to step 506. In step 506 the test account management system determines if there are any unprocessed inventory creation records. If the determination is that there are unprocessed inventory creation records, then operation proceeds from step 506 to step 508. However, if the determination is that there are not any unprocessed inventory creation records remaining to be processed, then operation proceeds from step 506 to subroutine return step 510.

Returning to step 508, in step 508 the test account management system obtains an unprocessed inventory creation record from inventory creation records 505 for processing. Operation proceeds from step 508 to step 512. In step 512 the test account management system determines if automated account creation is possible for the inventory creation record being processed based on the automation criteria 511. Operation proceeds from step 512 to step 514. In step 514 if the determination of step 512 is that automated creation is possible, then operation proceeds from step 514 to step 516 in which the test account management system performs an automated account creation generating generated new account 517. In step 514 if the determination of step 512 is that automated creation is not possible, then operation proceeds from step 514 to step 518 in which the test account management system determines if request creation is possible for the inventory creation record being processed based on the request criteria 519. Operation proceeds from step 518 to step 520. In step 520, if the determination of step 518 is that request creation is possible then operation proceeds from step 520 to step 522, in which a new test account, e.g., generated new account 523, is created using a request creation method, e.g., involving a generated request ticket and, in some embodiments, at least some manual intervention to set-up and/or authorize the new account. In step 520, if the determination of step 518 is that request creation is not possible then operation proceeds from step 520 to step 524, in which the test account management system reports an unprocessed need. Operation proceeds from any of steps 516, 522 or 524 to the input of step 506.

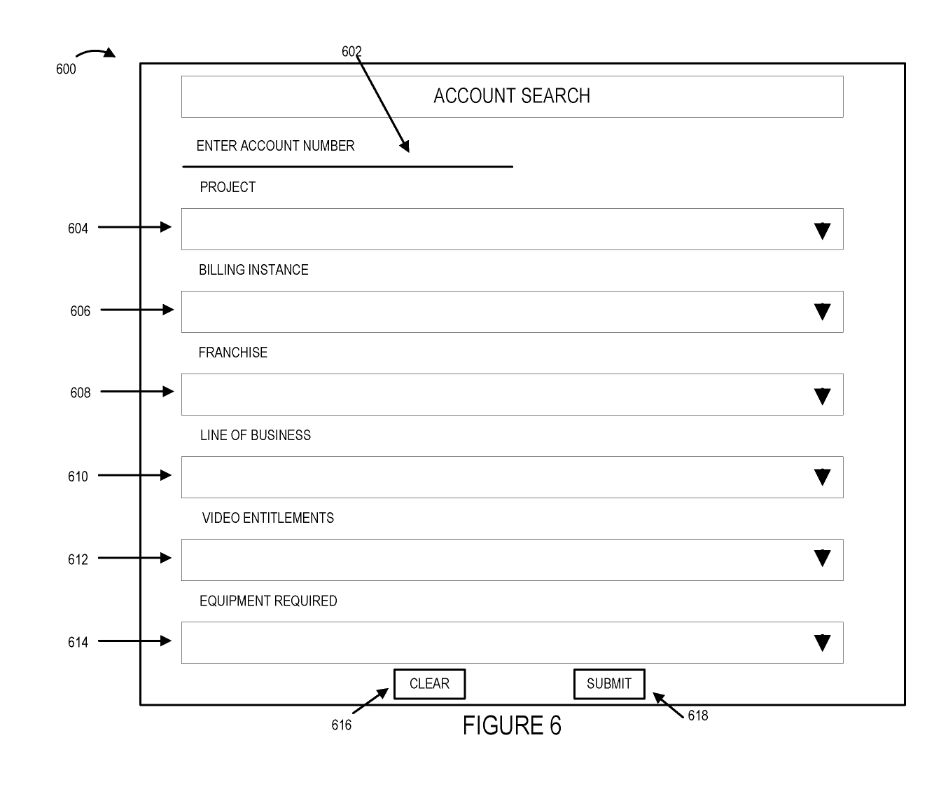

FIG. 6 is a drawing of a view of an exemplary test account search entry input display screen 600 in accordance with an exemplary embodiment. Account search input display screen 600 includes account number user input field 602, project user input field 604, billing instance user input field 606, franchise 606 user input field 608, line of business user input field 610, video entitlements user input field 612, video entitlements user input filed 612, and equipment required user input field 614. In some embodiments, for at least some fields, user input is entered into a search field via data entry, e.g., enter an account number into field 602. In some embodiments, for at least some fields, user input is entered into a search field via selection of options in a pull down menu. In various embodiments, a search field which has not received user input is treated as a wildcard condition when searching for test accounts in the account inventory to satisfy the search, e.g., it is not used to limit the accounts which are returned from a submitted search. Clear button 616 is used to clear the search entry input fields. Submit button 618 is used to submit a search, e.g., once the user has selected, e.g., entered, desired search inputs.

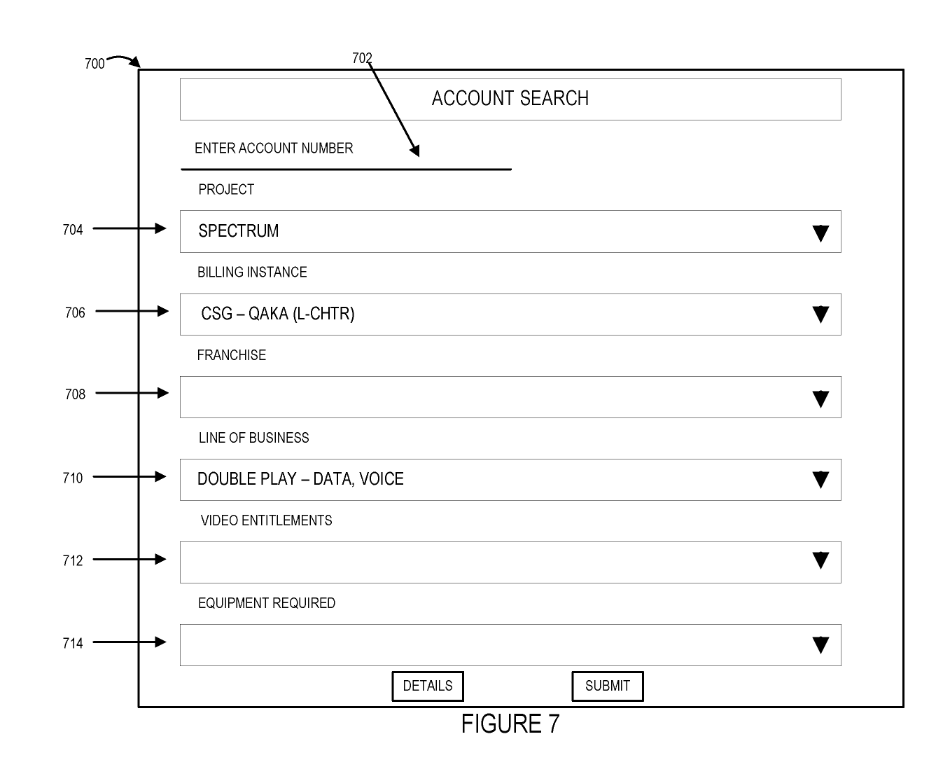

FIG. 7 is a drawing 700 of a view of an exemplary test account search entry input display screen 600 of FIG. 6 following user entered search inputs in some of the input search fields in accordance with an exemplary embodiment. There is no use input in the account number entry search field 702. The project input search field include user selected project “SPECTRUM” 704. The billing instance search field includes user selected “CSG-QAKA (L-CHTR) 706. There is no input in the franchise search field 708. The line of business search field includes “DOUBLE PLAY—DATA, VOICE” 710. There is no input in the video entitlements search field 712. There is no input in the equipment required search field 714.

Entries into search account search fields are test account information requirements for the search. The test account information requirements are searched against information elements in the test accounts in the inventory to find a set of test accounts which meets the search requirements. In one embodiment, if all the search fields are left bank or clear, the full test account inventory is returned as the search result. Thus the information selected for the test account search fields is used to narrow down the search results, e.g., finding matches which satisfy the user entered search criteria.

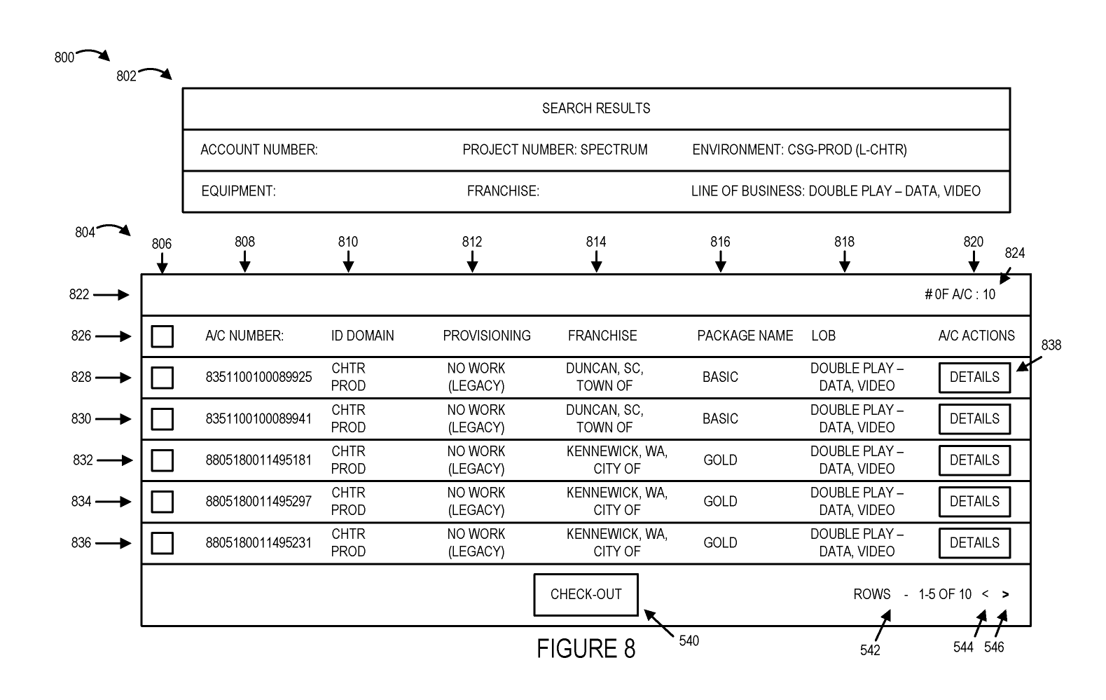

FIG. 8 is drawing of an exemplary search results display screen 800 corresponding to a submitted search with the search entries of FIG. 7 in accordance with an exemplary embodiment. Upper display drawing 802 indicates a high level summary of user entries corresponding to the search input of FIG. 7. Lower display drawing 804 is a first page of test accounts from the test account inventory which satisfied the search criteria. First column 806 includes boxes which may be checked to select and use the test account. Second column 808 lists account (A/C) number for the test accounts which satisfied the search criteria. Third column 810 lists ID domain for the test accounts which satisfied the search criteria. Fourth column 812 lists provisioning information for the test accounts which satisfied the search criteria. Fifth column 814 lists franchise corresponding to the test accounts which satisfied the search criteria. Sixth column 816 lists package name corresponding to the test accounts which satisfied the search criteria. Seventh column 818 lists line of business (LOB) information for the test accounts which satisfied the search criteria. Eight column 820 is an A/C action column and includes a “DETAILS” button, e.g., 838, for accessing more detailed information about the test account, when the details button is depressed or clicked on.

Information 824 in the upper right hand corner of Lower display drawing 804 indicates the number of test accounts in the account inventory which satisfied the entered search criteria, which is 10 in this case. Information 542 in the lower right hand corner of lower display drawing 804 indicates that rows 1-5 of 10 are being displayed. Clicking on symbol 546 is used to advance to see further entries in the returned search results, e.g., rows 6-10. Clicking on symbol 544 is used to go back in the returned search results. Clicking on check-out box 540 is used to access a selected test account which has been retuned in the test results, e.g., after the user selects one of the test accounts, e.g., by clicking on one of the boxes in column 806.

Row 822 includes the information 824 which specified how many test accounts satisfied the set of search inputs. Row 826 includes column header information. Rows (828, 830, 832, 834, 846) includes information corresponding to a (first, second, third, fourth, fifth) account, respectively, which satisfied the user input search criteria.

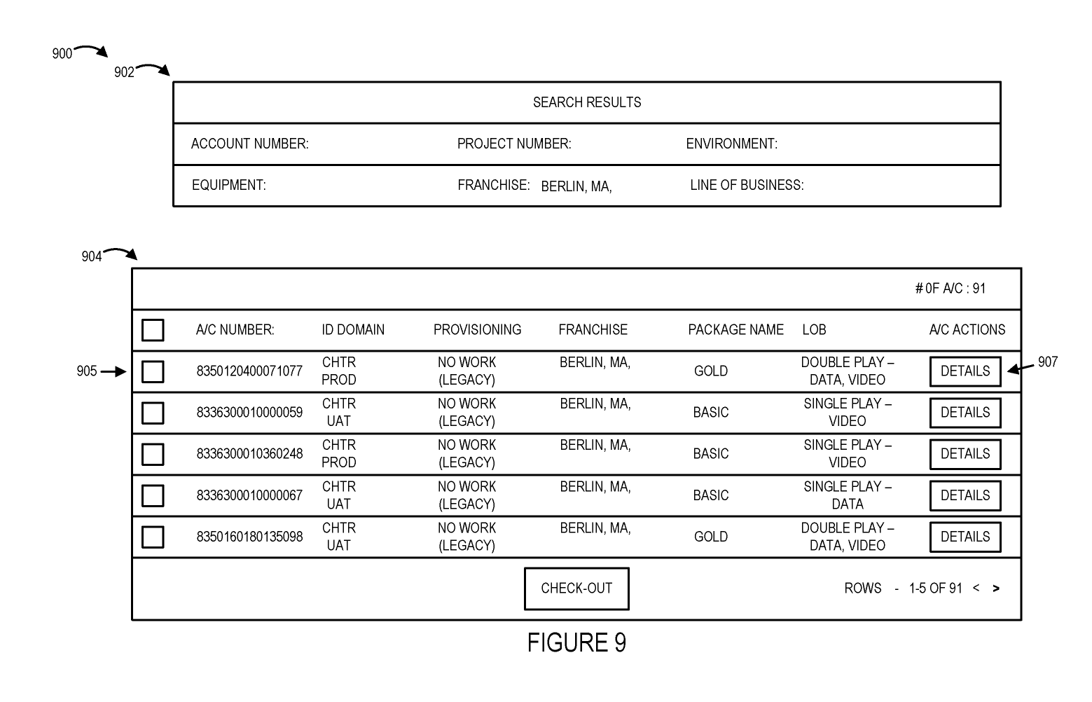

FIG. 9 is drawing of an exemplary search results display screen 900 corresponding to another exemplary submitted search in accordance with an exemplary embodiment. Upper display drawing 902 indicates a high level summary of user entries corresponding to the search input which indicates the selection of “Berlin, Mass.” in the franchise search field. Lower display drawing 904 is a first page of test accounts from the test account inventory which satisfied the search criteria, which indicates that 91 test accounts satisfied the search criteria and lists high level account information corresponding to the first 5 test accounts. Arrow 905 points to a first account which satisfied the search criteria. Note that each of the 5 displayed shown accounts have Berlin, Mass. for the franchise which matches the user input search entry. Details about the first account can be, and sometimes are obtained, e.g., displayed, by clicking on details button 907.

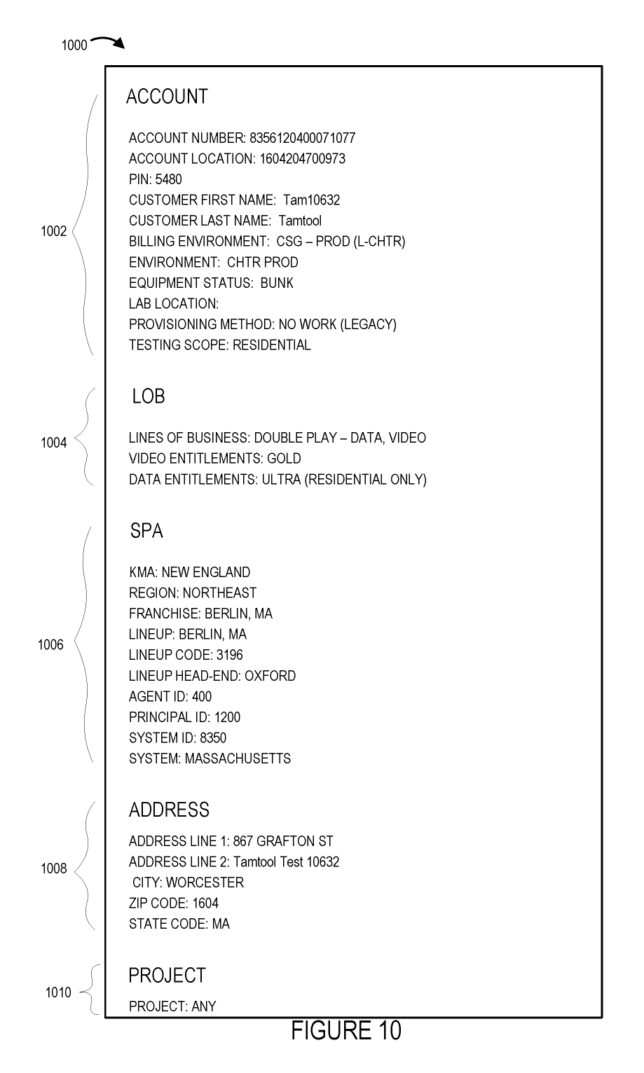

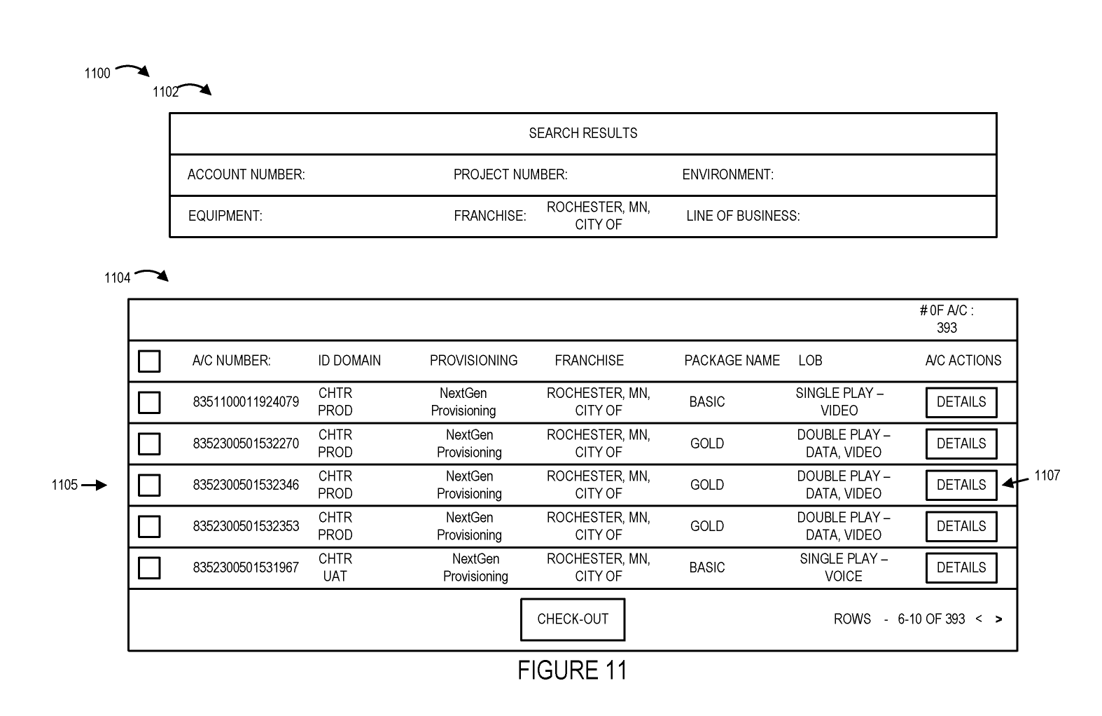

FIG. 10 is a drawing of an exemplary detailed account information display 1000 corresponding to the first test account shown in FIG. 9, e.g., shown in response to clicking on “Details” button 907. The information shown in FIG. 10 is a record of information elements corresponding to the test account. FIG. 10 shows exemplary information elements in one exemplary test account in a current inventory. Grouping 1002 includes various account type information elements including information element labels (account number, account location, PIN, Customer first name, customer last name, billing environment, environment, equipment status, lab location, provisioning method, testing scope) and corresponding information element values (8356120400071077, 1604204700973, 5480, Tam10632, Tamtool, CSG-PROD (L-CHTR), CHTR PROD, BUNK, no entry, No Work (Legacy), Residental), respectively.

Grouping 1004 includes various line of business type information elements including information element labels (lines of business, video entitlements, data entitlements) and corresponding information element values (Double Play—Data, Video; Gold; ULTRA (Residental only)), respectively.

Grouping 1006 includes various SPA type information elements including information element labels (KMA, Region, Franchise, Lineup, Line-Up Code, Line-Up Head-End, Agent ID, Principal ID, System ID, and System) and corresponding information element values (New England; Northeast; Berlin, Mass.; Berlin, Mass.; 3196, Oxford; 400; 1200; 8350; Massachusetts), respectively.

Grouping 1008 includes various Address type information elements including information element labels (Address Line 1, Address Line 2, City, Zip Code, State) and corresponding information element values (867 Grafton ST, Tamtool Test 10632, Worcester, 1604, MA), respectively.

Grouping 1010 includes various Project type information elements including information element labels (Project) and corresponding information element values (ANY), respectively.

FIG. 11 is drawing of an exemplary search results display screen 1100 corresponding to another exemplary submitted search in accordance with an exemplary embodiment. Upper display drawing 1102 indicates a high level summary of user entries corresponding to the search input which indicates the selection of “ROCHESTER, Minn., CITY OF” in the franchise search field. Lower display drawing 1104 is a second page of test accounts from the test account inventory which satisfied the search criteria, which indicates that 393 test accounts satisfied the search criteria and lists high level account information corresponding to the 6th-10 the test accounts in the returned search results. Arrow 1105 points to an 8th account which satisfied the search criteria. Note that each of the 5 displayed shown accounts have Rochester, Minn. for the franchise which matches the user input search entry. Details about the eighth account can be, and sometimes are obtained, e.g., displayed, by clicking on details button 1107.

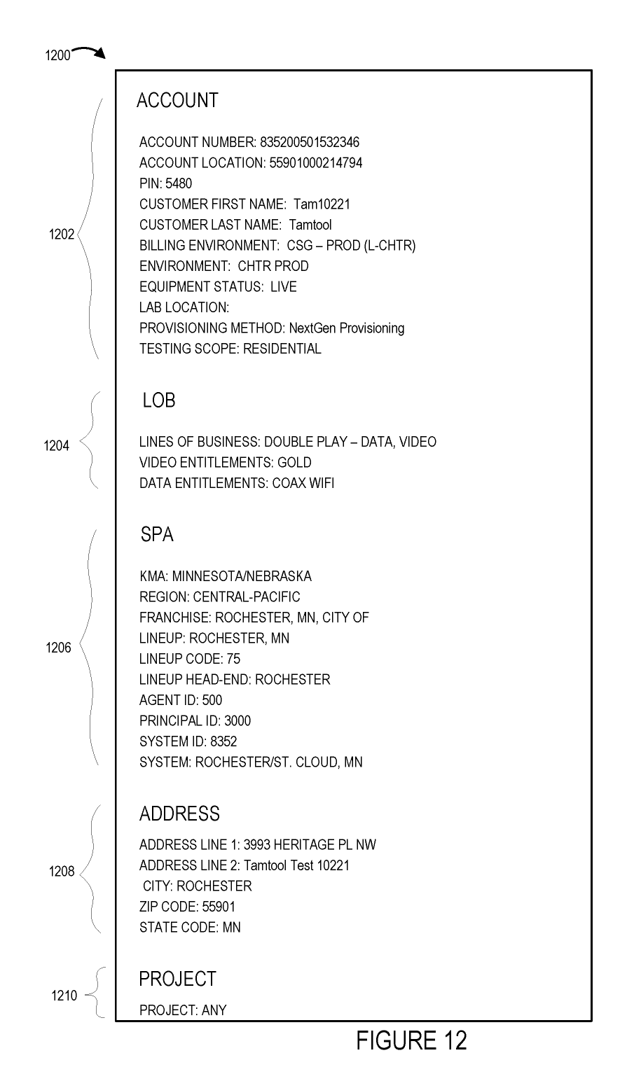

FIG. 12 is a drawing of an exemplary detailed account information display 1200 corresponding to the eighth test account shown in FIG. 11, e.g., shown in response to clicking on “Details” button 1107. The information shown in FIG. 12 is a record of information elements corresponding to the test account. FIG. 12 shows exemplary information elements in one exemplary test account in a current inventory. Grouping 1202 includes various account type information elements including information element labels (account number, account location, PIN, Customer first name, customer last name, billing environment, environment, equipment status, lab location, provisioning method, testing scope) and corresponding information element values (835200501532346, 55901000214794, 5480, Tam10221, Tamtool, CSG-PROD (L-CHTR), CHTR PROD, LIVE, no entry, NextGen Provisioning, Residental), respectively.

Grouping 1204 includes various line of business type information elements including information element labels (lines of business, video entitlements, data entitlements) and corresponding information element values (Double Play—Data, Video; Gold; Coax WiFi), respectively.

Grouping 1206 includes various SPA type information elements including information element labels (KMA, Region, Franchise, Lineup, Line-Up Code, Line-Up Head-End, Agent ID, Principal ID, System ID, and System) and corresponding information element values (Minnesota/Nebraska, Central-Pacific, Rochester, NN, City of; Rochester, Minn.; 75; Rochester; 500; 3000; 8352; Rochester/St. Cloud, Minn.), respectively.

Grouping 1208 includes various Address type information elements including information element labels (Address Line 1, Address Line 2, City, Zip Code, State) and corresponding information element values (3393 Heritage Pl NW, Tamtool Test 10221, Rochester, 55901, MN), respectively.

Grouping 1210 includes various Project type information elements including information element labels (Project) and corresponding information element values (ANY), respectively.

In various embodiments a blank information element value entry or “ANY” is considered a wildcard entry in the record for the account and will satisfy any search.

In some embodiments, equipment status: “BUNK” is used for a simulation type test account. In some such embodiments, the user of simulation test account may be and sometimes is, in the same location as the test account management system.

In some embodiments, equipment status: “LIVE” is used for an in-field test account, e.g., at a customer premise site or a service provider in-field testing facility.

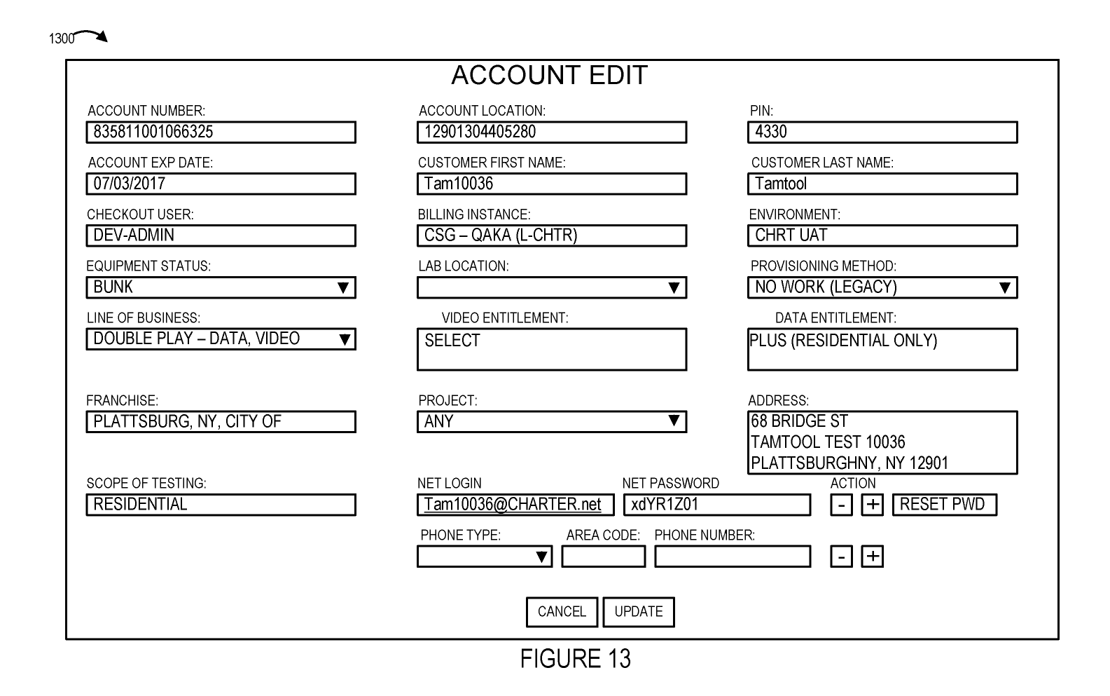

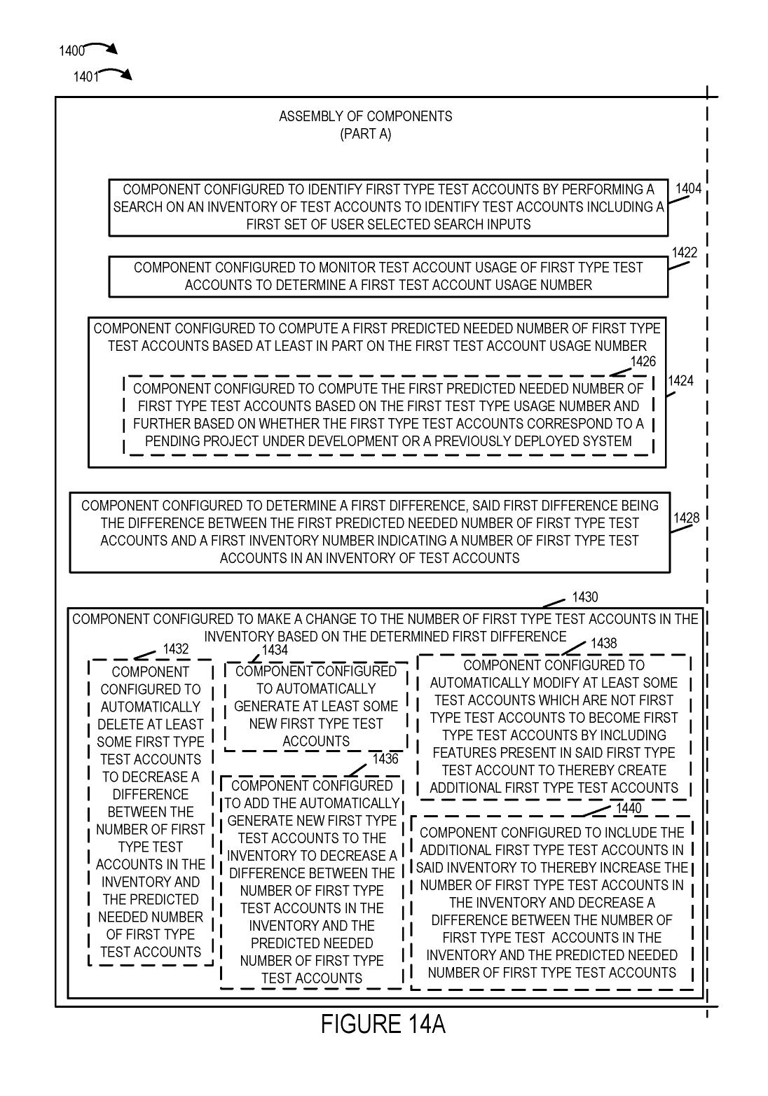

FIG. 13 is a drawing of an exemplary test account edit screen 1300 illustrating an exemplary account record including information elements which may be, and sometimes are edited, e.g., modified, in accordance with an exemplary embodiment In some embodiments, the test account management system performs automatic account modifications, e.g. edits, to existing test accounts in response to predicted test account needs.

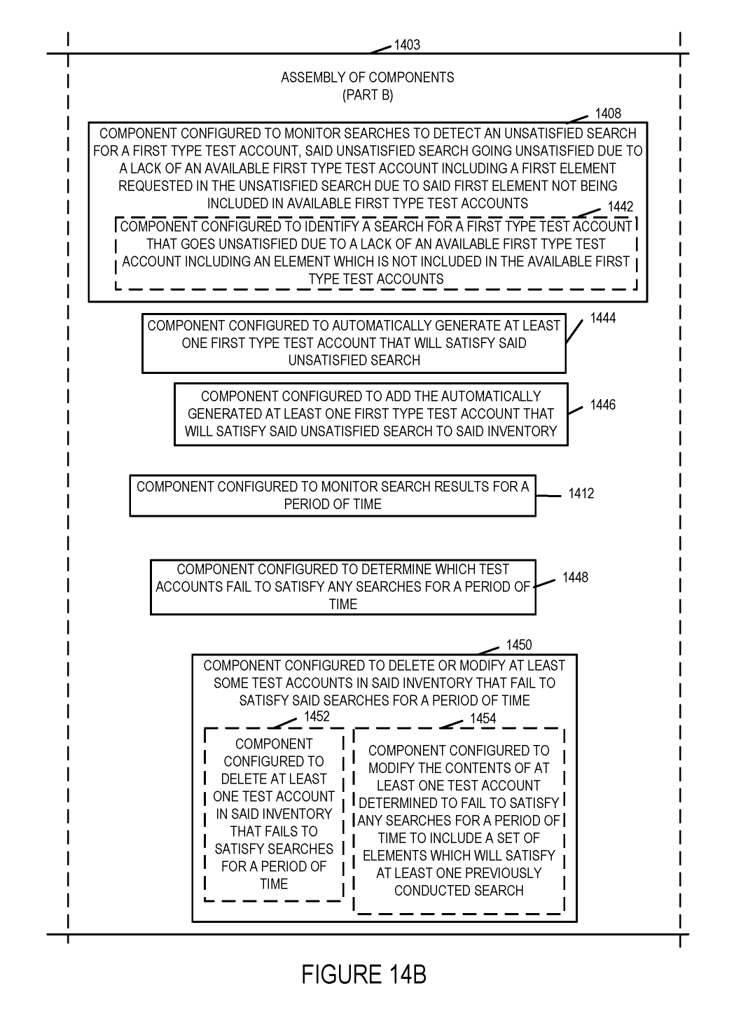

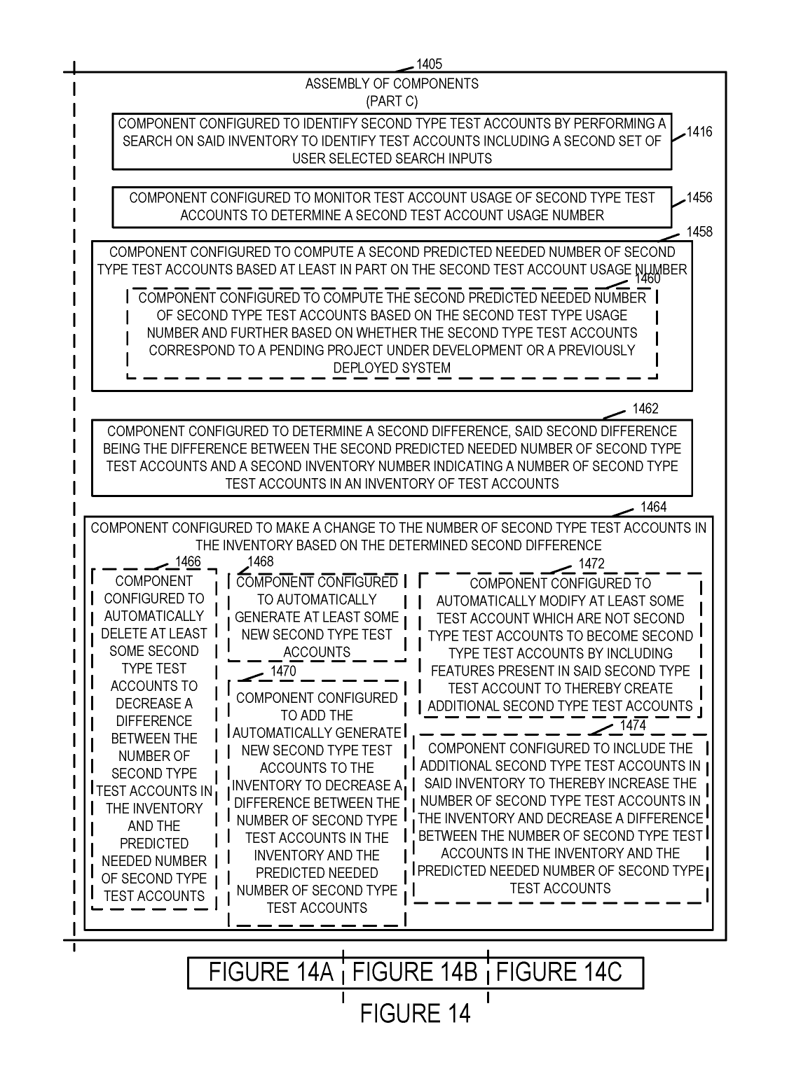

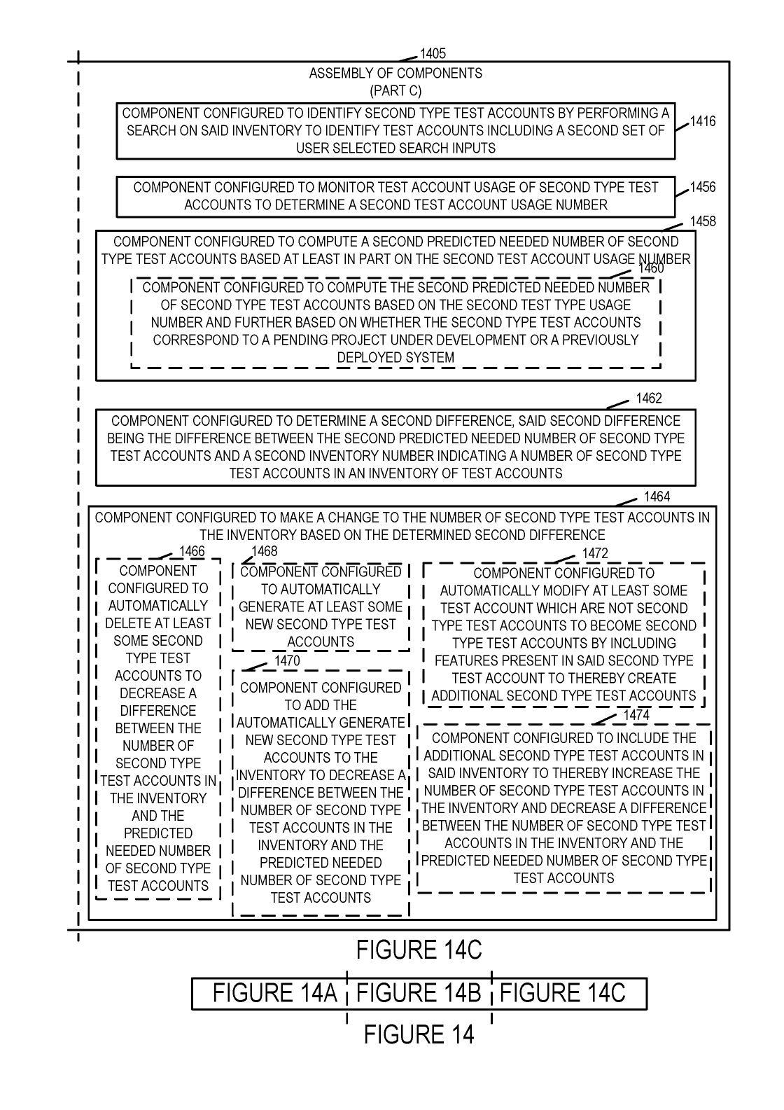

FIG. 14 is a drawing of an exemplary assembly of components 1400 which may be included in exemplary test account management system, e.g., test account management system 116 of FIG. 1 and/or test account management system 200 of FIG. 2, in accordance with an exemplary embodiment. Assembly of components 1400 can be, and in some embodiments is, used in test account management system 200, e.g., a test account management device. The components in the assembly of components 1400 can, and in some embodiments are, implemented fully in hardware within the processor 202, e.g., as individual circuits. The components in the assembly of components 1400 can, and in some embodiments are, implemented fully in hardware within the assembly of hardware components 204, e.g., as individual circuits corresponding to the different components. In other embodiments some of the components are implemented, e.g., as circuits, within the processor 202 with other components being implemented, e.g., as circuits within assembly of components 204, external to and coupled to the processor 202. As should be appreciated the level of integration of components on the processor and/or with some components being external to the processor may be one of design choice. Alternatively, rather than being implemented as circuits, all or some of the components may be implemented in software and stored in the memory 212 of the test account management device 200, with the components controlling operation of device 200 to implement the functions corresponding to the components when the components are executed by a processor, e.g., processor 202. In some such embodiments, the assembly of components 1400 is included in the memory 212 as assembly of software components 220. In still other embodiments, various components in assembly of components 1200 are implemented as a combination of hardware and software, e.g., with another circuit external to the processor providing input to the processor 2002 which then under software control operates to perform a portion of a component's function. While processor 202 is shown in the FIG. 2 embodiment as a single processor, e.g., computer, it should be appreciated that the processor 202 may be implemented as one or more processors, e.g., computers.

When implemented in software the components include code, which when executed by the processor 202, configure the processor 202 to implement the function corresponding to the component. In embodiments where the assembly of components 1400 is stored in the memory 212, the memory 212 is a computer program product comprising a computer readable medium comprising code, e.g., individual code for each component, for causing at least one computer, e.g., processor 202, to implement the functions to which the components correspond.

Completely hardware based or completely software based components may be used. However, it should be appreciated that any combination of software and hardware, e.g., circuit implemented components may be used to implement the functions. As should be appreciated, the components illustrated in FIG. 14 control and/or configure the test account management device 200 or elements therein such as the processor 202, to perform the functions of corresponding steps illustrated and/or described in the method of one or more of the flowcharts, signaling diagrams and/or described with respect to any of the Figures. Thus the assembly of components 2600 includes various components that perform functions of corresponding one or more described and/or illustrated steps of an exemplary method, e.g., one or more steps of the method of FIG. 3, FIG. 4 and/or FIG. 5.

FIG. 14, comprising the combination of FIG. 14A, FIG. 14B and FIG. 14C, is a drawing of an exemplary assembly of components 1400, comprising Part A 1401, Part B 1403 and Part C 1405, in accordance with an exemplary embodiment. Assembly of components 1400 includes a component 1404 configured to identify first type test accounts by performing a search of an inventory of test accounts to identify test accounts including a first set of user selected search inputs, a component 1422 configured to monitor test account usage of first type test accounts to determine a first test account usage number, and a component 1424 configured to compute a first predicted needed number of first type test accounts based at least in part on the first test account usage number. Component 1424 includes a component 1426 configured to compute the first predicted needed number of first type test accounts based on the first test type usage number and further based on whether the first type test accounts correspond to a pending project under development or a previously deployed system. Assembly of components 1400 further includes a component 1428 configured to determine a first difference, said first difference being the difference between the first predicted needed number of first type test accounts and a first inventory number indicating a number of first type test accounts in an inventory of test accounts, and a component 1430 configured to make a change to the number of first type test accounts in the inventory based on the determined first difference. Component 1430 includes a component 1432 configured to automatically delete at least some first type test accounts to decrease a difference between the number of first type test accounts in the inventory and the predicted needed number of first type test accounts, a component 1434 configured to automatically generate at least some new first type test accounts, a component 1436 configured to add the automatically generated new first type test accounts to the inventory to decrease a difference between the number of first type test accounts in the inventory and the predicted needed number of first type test accounts, a component 1438 configured to automatically modify at least some test accounts which are not first type test accounts to become first type test accounts by including features present in said first type test account to thereby create additional first type test accounts, and a component 1440 configure to include the additional first type test accounts in said inventory to thereby increase the number of first type test accounts in the inventory and decrease a difference between the number of first type test accounts in the inventory and the predicted needed number of first type test accounts.

Assembly of components 1400 further includes a component 1408 configured to monitor searches to detect an unsatisfied search for a first type test account, said unsatisfied search going unsatisfied due to a lack of an available first type test account including a first element requested in the unsatisfied search due to said first element not being included in available first type test accounts. Component 1408 includes a component 1442 configured to identity a search for a first type test account that goes unsatisfied due to a lack of an available first type test account including an element which is not included in the available first type test accounts. Assembly of components 1400 further includes a component 1444 configured to automatically generate at least one first type test account that will satisfy said unsatisfied search, a component 1446 configured to add the automatically generated at least one first type test account that will satisfy said unsatisfied search to said inventory.

Assembly of components 1400 further includes a component 1412 configured to monitor search results for a period of time, a component 1448 configured to determine which test accounts fail to satisfy any searches for a period of time, an a component 1450 configured to delete or modify at least some test accounts in said inventory that fail to satisfy said searches for a period of time. Component 1450 includes a component 1452 configured to delete at least one test account in said inventory that fails to satisfy searches for a period of time, and a component 1454 configured to modify the contents of at least one test account determined to fail to satisfy any searches for a period to time to includes a set of elements which will satisfy at least one previously conducted search.

Assembly of components 1400 includes a component 1416 configured to identify second type test accounts by performing a search of an inventory of test accounts to identify test accounts including a second set of user selected search inputs, a component 1456 configured to monitor test account usage of second type test accounts to determine a second test account usage number, and a component 1458 configured to compute a second predicted needed number of second type test accounts based at least in part on the second test account usage number. Component 1458 includes a component 1460 configured to compute the second predicted needed number of second type test accounts based on the second test type usage number and further based on whether the second type test accounts correspond to a pending project under development or a previously deployed system. Assembly of components 1400 further includes a component 1462 configured to determine a second difference, said second difference being the difference between the second predicted needed number of second type test accounts and a second inventory number indicating a number of second type test accounts in an inventory of test accounts, and a component 1464 configured to make a change to the number of second type test accounts in the inventory based on the determined second difference. Component 1464 includes a component 1466 configured to automatically delete at least some second type test accounts to decrease a difference between the number of second type test accounts in the inventory and the predicted needed number of second type test accounts, a component 1468 configured to automatically generate at least some new second type test accounts, a component 1470 configured to add the automatically generated new second type test accounts to the inventory to decrease a difference between the number of second type test accounts in the inventory and the predicted needed number of second type test accounts, a component 1472 configured to automatically modify at least some test accounts which are not second type test accounts to become second type test accounts by including features present in said second type test account to thereby create additional second type test accounts, and a component 1474 configured to include the additional second type test accounts in said inventory to thereby increase the number of second type test accounts in the inventory and decrease a difference between the number of second type test accounts in the inventory and the predicted needed number of second type test accounts.

Set forth below are various exemplary numbered embodiments. Each set of numbered exemplary embodiments is numbered by itself with embodiments in a set referring to previous numbered embodiments in the same set.

### List of Set of Exemplary Numbered Method Embodiments

### Method Embodiment 1

A method of automated test account management, the method comprising: monitoring, at a test account management system, test account usage of first type test accounts to determine a first test account usage number (e.g., a number of first type test accounts used [e.g. checked out for use in testing] during a first time period); computing a first predicted needed number of first type test accounts based at least in part on the first test account usage number (e.g. predict how many first type test accounts will be needed in an upcoming time period); determining a first difference, said first difference being the difference between the first predicted needed number of first type test accounts and a first inventory number indicating a number of first type test accounts in an inventory of test accounts; and making a change to the number of first type test accounts in the inventory based on the determined first difference.

### Method Embodiment 2

The method of method embodiment 1, wherein computing a first predicted needed number of first type test accounts is further based on whether the first type test accounts correspond to a pending project underdevelopment or a previously deployed service.

### Method Embodiment 3

The method of method embodiment 1 wherein said first type test accounts are accounts which satisfy a first set of test account information requirements.

### Method Embodiment 4

The method of method embodiment 1, wherein making a change to the number of first type test accounts in the inventory based on the determined first difference includes automatically deleting at least some first type test accounts to decrease a difference between the number of first type test accounts in the inventory and the predicted needed number of first type test accounts.

### Method Embodiment 5

The method of method embodiment 1, wherein making a change to the number of first type test accounts in the inventory based on the determined first difference includes: automatically generating at least some new first type test accounts; and adding the automatically generated new first type test accounts to the inventory to decrease a difference between the number of first type test accounts in the inventory and the predicted needed number of first type test accounts.

### Method Embodiment 6

The method of method embodiment 1, wherein making a change to the number of first type test accounts in the inventory based on the determined first difference includes: automatically modifying at least some test accounts which are not first type test accounts to become first type test accounts by including account features present in said first type test accounts to thereby create additional first type test accounts; and including the additional first type test accounts in said inventory to thereby increase the number of first type test accounts in said inventory and decrease a difference between the number of first type test accounts in the inventory and the predicted needed number of first type test accounts.

### Method Embodiment 7

The method of method embodiment 3, further comprising: prior to monitoring test account usage of first type test accounts, identifying first type test accounts by performing a search on said inventory to identify test accounts including a first set of user selected search inputs.

### Method Embodiment 8

The method of method embodiment 7, wherein said user selected search inputs include at least two of a project, billing instance, provisioning method and franchise.

### Method Embodiment 9

The method of method embodiment 8, wherein said user selected search inputs include at least two of a line of business, video entitlements, and equipment required.

### Method Embodiment 10

The method of method embodiment 8, wherein said user selected search inputs include at least two of a billing environment, equipment status, and equipment status.

### Method Embodiment 11

The method of method embodiment 1, further comprising: monitoring searches to detect an unsatisfied search for a first type test account, said unsatisfied search going unsatisfied due to a lack of an available first type test account including a first element requested in the unsatisfied search due to said first element not being included in available first type test accounts; and in response to identifying the search for a first type test account that goes unsatisfied due to a lack of an available first type test account including an element which is not included in available first type test accounts: automatically generating at least one first type test account that will satisfy said unsatisfied search; and adding the automatically generated at least one first type test account that will satisfy said unsatisfied search to said inventory.

### Method Embodiment 12

The method of method embodiment 1, further comprising: monitoring search results for a period of time; determining which test accounts fail to satisfy any searches for a period of time; and deleting or modifying at least some test accounts in said inventory that fail to satisfy any searches for the period of time.

### Method Embodiment 13

The method of method embodiment 12, wherein deleting or modifying at least some test accounts that fail to satisfy any searches for the period of time includes: modifying the contents of at least one test account determined to fail to satisfy any searches for a period of time to include a set of elements which will satisfy at least one previously conducted search.

### Method Embodiment 14

The method of method embodiment 13, further comprising monitoring test account usage of second type test accounts to determine a second test account usage number (e.g., a number of second type test accounts used (e.g. checked out for use in testing) during the first time period); computing a second predicted needed number of second type test accounts based at least in part on the second test account usage number (e.g. predict how many first type test accounts will be needed in an upcoming time period); determining a second difference, said second difference being the difference between the second predicted needed number of second type test accounts and a second inventory number indicating a number of second type test accounts in an inventory of test accounts; and making a change to the number of second type test accounts in the inventory based on the determined second difference.

### Method Embodiment 15

The method of method embodiment 14, wherein computing a second predicted needed number of second type test accounts is further based on whether the second type test accounts correspond to a pending project underdevelopment or a previously deployed service.

### Method Embodiment 16

The method of method embodiment 14 wherein said second type test accounts are accounts which satisfy a second set of test account features, said second set of test account features being different from the first set of test account features.

### List of Set of Exemplary Numbered Apparatus Embodiments

### Apparatus Embodiment 1

A test account management apparatus comprising: a processor configured to control the test account management system to: monitor test account usage of first type test accounts to determine a first test account usage number (e.g., a number of first type test accounts used (e.g. checked out for use in testing) during a first time period); compute a first predicted needed number of first type test accounts based at least in part on the first test account usage number (e.g. predict how many first type test accounts will be needed in an upcoming time period); determine a first difference, said first difference being the difference between the first predicted needed number of first type test accounts and a first inventory number indicating a number of first type test accounts in an inventory of test accounts; and make a change to the number of first type test accounts in the inventory based on the determined first difference; and memory coupled to said processor.

### Apparatus Embodiment 2

The test account management apparatus of apparatus embodiment 1, wherein said processor is configured to compute the first predicted needed number of first type test accounts based on whether the first type test accounts correspond to a pending project underdevelopment or a previously deployed service.

### Apparatus Embodiment 3

The test account management apparatus of apparatus embodiment 1 wherein said first type test accounts are accounts which satisfy a first set of test account information requirements.

### Apparatus Embodiment 4

The test account management apparatus of apparatus embodiment 1, wherein said processor is configured to: automatically delete at least some first type test accounts to decrease a difference between the number of first type test accounts in the inventory and the predicted needed number of first type test accounts, as part of being configured to make a change to the number of first type test accounts in the inventory based on the determined first difference.

### Apparatus Embodiment 5

The test account management apparatus of apparatus embodiment 1, wherein said processor is configured to: automatically generate at least some new first type test accounts; and add the automatically generated new first type test accounts to the inventory to decrease a difference between the number of first type test accounts in the inventory and the predicted needed number of first type test accounts, as part or being configured to make a change to the number of first type test accounts in the inventory based on the determined first difference.

### Apparatus Embodiment 6

The test account management apparatus of apparatus embodiment 1, wherein said processor is configured to: automatically modify at least some test accounts which are not first type test accounts to become first type test accounts by including account features present in said first type test accounts to thereby create additional first type test accounts; and include the additional first type test accounts in said inventory to thereby increase the number of first type test accounts in said inventory and decrease a difference between the number of first type test accounts in the inventory and the predicted needed number of first type test accounts, as part of being configured to make a change to the number of first type test accounts in the inventory based on the determined first difference.

### Apparatus Embodiment 7

The test account management apparatus of apparatus embodiment 3, wherein said processor is further configured to: identify first type test accounts by performing a search on said inventory to identify test accounts including a first set of user selected search inputs, said identifying first type test accounts being performed prior to monitoring test account usage of first type test accounts.

### Apparatus Embodiment 8

The test account management apparatus of apparatus embodiment 7, wherein said user selected search inputs include at least two of a project, billing instance, provisioning method and franchise.

### Apparatus Embodiment 9

The test account management apparatus of claim 8, wherein said user selected search inputs include at least two of a line of business, video entitlements, and equipment required.

### Apparatus Embodiment 10

The test account management apparatus of apparatus embodiment 8, wherein said user selected search inputs include at least two of a billing environment, equipment status, and equipment status.

### Apparatus Embodiment 11

The test account management apparatus of apparatus embodiment 1, wherein said processor is further configured to: monitor searches to detect an unsatisfied search for a first type test account, said unsatisfied search going unsatisfied due to a lack of an available first type test account including a first element requested in the unsatisfied search due to said first element not being included in available first type test accounts; and in response to identifying the search for a first type test account that goes unsatisfied due to a lack of an available first type test account including an element which is not included in available first type test accounts: automatically generate at least one first type test account that will satisfy said unsatisfied search; and add the automatically generated at least one first type test account that will satisfy said unsatisfied search to said inventory.

### Apparatus Embodiment 12

The test account management apparatus of apparatus embodiment 1, wherein said processor is further configured to: monitor search results for a period of time; determine which test accounts fail to satisfy any searches for a period of time; and delete or modify at least some test accounts in said inventory that fail to satisfy any searches for the period of time.

### Apparatus Embodiment 13

The test account management apparatus of apparatus embodiment 12, wherein said processor is configured to: modify the contents of at least one test account determined to fail to satisfy any searches for a period of time to include a set of elements which will satisfy at least one previously conducted search, as part of being configured to delete or modify at least some test accounts that fail to satisfy any searches for the period of time.

### Apparatus Embodiment 14

The test account management apparatus of apparatus embodiment 13, wherein said processor is further configured to: monitor test account usage of second type test accounts to determine a second test account usage number (e.g., a number of second type test accounts used [e.g. checked out for use in testing] during the first time period); compute a second predicted needed number of second type test accounts based at least in part on the second test account usage number (e.g. predict how many first type test accounts will be needed in an upcoming time period); determine a second difference, said second difference being the difference between the second predicted needed number of second type test accounts and a second inventory number indicating a number of second type test accounts in an inventory of test accounts; and make a change to the number of second type test accounts in the inventory based on the determined second difference.

### Apparatus Embodiment 15

The test account management apparatus of apparatus embodiment 14, wherein said processor is configured to compute the second predicted needed number of second type test accounts based on whether the second type test accounts correspond to a pending project underdevelopment or a previously deployed service.

### Apparatus Embodiment 16

The test account management apparatus of apparatus embodiment 14, wherein said second type test accounts are accounts which satisfy a second set of test account features, said second set of test account features being different from the first set of test account features.

### Computer Readable Medium Embodiment

A non-transitory computer readable medium including processor executable instructions which, when executed by a processor of a test account management apparatus, control the test account management apparatus to perform the steps of: monitoring test account usage of first type test accounts to determine a first test account usage number; computing a first predicted needed number of first type test accounts based at least in part on the first test account usage number; determining a first difference, said first difference being the difference between the first predicted needed number of first type test accounts and a first inventory number indicating a number of first type test accounts in an inventory of test accounts; and making a change to the number of first type test accounts in the inventory based on the determined first difference.

The techniques of various embodiments may be implemented using software, hardware and/or a combination of software and hardware. Various embodiments are directed to apparatus, e.g., customer premise equipment devices, cable systems, network nodes, cable headend/hubsites, network monitoring node/servers, cluster controllers, cloud nodes, production nodes, cloud services servers and/or network equipment devices. Various embodiments are also directed to methods, e.g., method of controlling and/or operating cable networks, cloud networks, nodes, servers, cloud service servers, customer premise equipment devices, controllers, network monitoring nodes/servers and/or cable or network equipment devices. Various embodiments are also directed to machine, e.g., computer, readable medium, e.g., ROM, RAM, CDs, hard discs, etc., which include machine readable instructions for controlling a machine to implement one or more steps of a method. The computer readable medium is, e.g., non-transitory computer readable medium.

It is understood that the specific order or hierarchy of steps in the processes and methods disclosed is an example of exemplary approaches. Based upon design preferences, it is understood that the specific order or hierarchy of steps in the processes and methods may be rearranged while remaining within the scope of the present disclosure. The accompanying method claims present elements of the various steps in a sample order, and are not meant to be limited to the specific order or hierarchy presented. In some embodiments, one or more processors are used to carry out one or more steps of the each of the described methods.

In various embodiments each of the steps or elements of a method are implemented using one or more processors. In some embodiments, each of elements are steps are implemented using hardware circuitry.

In various embodiments nodes and/or elements described herein are implemented using one or more components to perform the steps corresponding to one or more methods, for example, message reception, signal processing, sending, comparing, determining and/or transmission steps. Thus, in some embodiments various features are implemented using components or in some embodiments logic such as for example logic circuits. Such components may be implemented using software, hardware or a combination of software and hardware. Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods, e.g., in one or more nodes. Accordingly, among other things, various embodiments are directed to a machine-readable medium, e.g., a non-transitory computer readable medium, including machine executable instructions for causing a machine, e.g., processor and associated hardware, to perform one or more of the steps of the above-described method(s). Some embodiments are directed to a device, e.g., a controller, including a processor configured to implement one, multiple or all of the steps of one or more methods of the invention.

In some embodiments, the processor or processors, e.g., CPUs, of one or more devices, e.g., communications nodes such as controllers are configured to perform the steps of the methods described as being performed by the communications nodes, e.g., controllers. The configuration of the processor may be achieved by using one or more components, e.g., software components, to control processor configuration and/or by including hardware in the processor, e.g., hardware components, to perform the recited steps and/or control processor configuration. Accordingly, some but not all embodiments are directed to a device, e.g., communications node such as a cluster controller including, with a processor which includes a component corresponding to each of the steps of the various described methods performed by the device in which the processor is included. In some but not all embodiments a device, e.g., communications node such as a controller, includes a controller corresponding to each of the steps of the various described methods performed by the device in which the processor is included. The components may be implemented using software and/or hardware.

Some embodiments are directed to a computer program product comprising a computer-readable medium, e.g., a non-transitory computer-readable medium, comprising code for causing a computer, or multiple computers, to implement various functions, steps, acts and/or operations, e.g. one or more steps described above. Depending on the embodiment, the computer program product can, and sometimes does, include different code for each step to be performed. Thus, the computer program product may, and sometimes does, include code for each individual step of a method, e.g., a method of controlling a controller or node. The code may be in the form of machine, e.g., computer, executable instructions stored on a computer-readable medium, e.g., a non-transitory computer-readable medium, such as a RAM (Random Access Memory), ROM (Read Only Memory) or other type of storage device. In addition to being directed to a computer program product, some embodiments are directed to a processor configured to implement one or more of the various functions, steps, acts and/or operations of one or more methods described above. Accordingly, some embodiments are directed to a processor, e.g., CPU, configured to implement some or all of the steps of the methods described herein. The processor may be for use in, e.g., a communications device such as a controller or other device described in the present application. In some embodiments components are implemented as hardware devices in such embodiments the components are hardware components. In other embodiments components may be implemented as software, e.g., a set of processor or computer executable instructions. Depending on the embodiment the components may be all hardware components, all software components, a combination of hardware and/or software or in some embodiments some components are hardware components while other components are software components.

Numerous additional variations on the methods and apparatus of the various embodiments described above will be apparent to those skilled in the art in view of the above description. Such variations are to be considered within the scope. Numerous additional embodiments, within the scope of the present invention, will be apparent to those of ordinary skill in the art in view of the above description and the claims which follow. Such variations are to be considered within the scope of the invention.

What is claimed is:

1. A method of automated test account management, the method comprising:
monitoring, at a test account management system, test account usage of first type test accounts to determine a first test account usage number;
computing, at the at a test account management system, a first predicted needed number of first type test accounts based at least in part on the first test account usage number;
determining a first difference, said first difference being the difference between the first predicted needed number of first type test accounts and a first inventory number indicating a number of first type test accounts in an inventory of test accounts; and
making a change to the number of first type test accounts in the inventory based on the determined first difference.

2. The method of claim 1, wherein computing a first predicted needed number of first type test accounts is further based on whether the first type test accounts correspond to a pending project underdevelopment or a previously deployed service.

3. The method of claim 1 wherein said first type test accounts are accounts which satisfy a first set of test account information requirements.

4. The method of claim 1, wherein making a change to the number of first type test accounts in the inventory based on the determined first difference includes automatically deleting at least some first type test accounts to decrease a difference between the number of first type test accounts in the inventory and the predicted needed number of first type test accounts.

5. The method of claim 1, wherein making a change to the number of first type test accounts in the inventory based on the determined first difference includes:
automatically generating at least some new first type test accounts; and
adding the automatically generated new first type test accounts to the inventory to decrease a difference between the number of first type test accounts in the inventory and the predicted needed number of first type test accounts.

6. The method of claim 1, wherein making a change to the number of first type test accounts in the inventory based on the determined first difference includes:
automatically modifying at least some test accounts which are not first type test accounts to become first type test accounts by including account features present in said first type test accounts to thereby create additional first type test accounts; and
including the additional first type test accounts in said inventory to thereby increase the number of first type test accounts in said inventory and decrease a difference between the number of first type test accounts in the inventory and the predicted needed number of first type test accounts.

7. The method of claim 3, further comprising:
prior to monitoring test account usage of first type test accounts, identifying first type test accounts by performing a search on said inventory to identify test accounts including a first set of user selected search inputs.

8. The method of claim 7, wherein said user selected search inputs include at least two of a project, billing instance, provisioning method and franchise.

9. The method of claim 1, further comprising:
monitoring searches to detect an unsatisfied search for a first type test account, said unsatisfied search going unsatisfied due to a lack of an available first type test account including a first element requested in the unsatisfied search due to said first element not being included in available first type test accounts; and
in response to identifying the search for a first type test account that goes unsatisfied due to a lack of an available first type test account including an element which is not included in available first type test accounts:
automatically generating at least one first type test account that will satisfy said unsatisfied search; and
adding the automatically generated at least one first type test account that will satisfy said unsatisfied search to said inventory.

10. The method of claim 1, further comprising:
monitoring search results for a period of time;
determining which test accounts fail to satisfy any searches for a period of time; and
deleting or modifying at least some test accounts in said inventory that fail to satisfy any searches for the period of time.

11. The method of claim 10, wherein deleting or modifying at least some test accounts that fail to satisfy any searches for the period of time includes:
modifying the contents of at least one test account determined to fail to satisfy any searches for a period of time to include a set of elements which will satisfy at least one previously conducted search.

12. The method of claim 11, further comprising monitoring test account usage of second type test accounts to determine a second test account usage number;
computing a second predicted needed number of second type test accounts based at least in part on the second test account usage number;
determining a second difference, said second difference being the difference between the second predicted needed number of second type test accounts and a second inventory number indicating a number of second type test accounts in an inventory of test accounts; and
making a change to the number of second type test accounts in the inventory based on the determined second difference.

13. The method of claim 12, wherein computing a second predicted needed number of second type test accounts is further based on whether the second type test accounts correspond to a pending project underdevelopment or a previously deployed service.

14. The method of claim 12 wherein said second type test accounts are accounts which satisfy a second set of test account features, said second set of test account features being different from the first set of test account features.

15. A test account management apparatus comprising:
a processor configured to control the test account management system to:
monitor test account usage of first type test accounts to determine a first test account usage;
compute a first predicted needed number of first type test accounts based at least in part on the first test account usage number;
determine a first difference, said first difference being the difference between the first predicted needed number of first type test accounts and a first inventory number indicating a number of first type test accounts in an inventory of test accounts; and
make a change to the number of first type test accounts in the inventory based on the determined first difference; and
memory coupled to said processor.

16. The test account management apparatus of claim 15, wherein said processor is configured to compute the first predicted needed number of first type test accounts based on whether the first type test accounts correspond to a pending project underdevelopment or a previously deployed service.

17. The test account management apparatus of claim 15, wherein said first type test accounts are accounts which satisfy a first set of test account information requirements.

18. The test account management apparatus of claim 15, wherein said processor is configured to:
automatically delete at least some first type test accounts to decrease a difference between the number of first type test accounts in the inventory and the predicted needed number of first type test accounts, as part of being configured to make a change to the number of first type test accounts in the inventory based on the determined first difference.

19. The test account management apparatus of claim 15, wherein said processor is configured to:
automatically generate at least some new first type test accounts; and
add the automatically generated new first type test accounts to the inventory to decrease a difference between the number of first type test accounts in the inventory and the predicted needed number of first type test accounts,
as part or being configured to make a change to the number of first type test accounts in the inventory based on the determined first difference.

20. A non-transitory computer readable medium including processor executable instructions which, when executed by a processor of a test account management apparatus, control the test account management apparatus to perform the steps of:
monitoring test account usage of first type test accounts to determine a first test account usage number;
computing a first predicted needed number of first type test accounts based at least in part on the first test account usage number;
determining a first difference, said first difference being the difference between the first predicted needed number of first type test accounts and a first inventory number indicating a number of first type test accounts in an inventory of test accounts; and
making a change to the number of first type test accounts in the inventory based on the determined first difference.
